(19) United States
(12) Patent Application Publication
(10) Pub. No.: US 2007/0215266 A1
(43) Pub. Date: Sep. 20, 2007

(54) Run-Flat Tire Support, Manufacturing Method Therefor, and a Run-Flat Tire with the Run-Flat Tire Support Fixedly Mounted Thereto

(75) Inventors: Toshiki Shimizu, Osaka (JP); Yoshio Mimura, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOYO TIRE & RUBBER CO., LTD., Osaka (JP)

(21) Appl. No.: 11/587,546

(22) PCT Filed: Apr. 25, 2005
(86) PCT No.: PCT/JP05/07821

§ 371 Date: Oct. 25, 2006

(30) Foreign Application Priority Data
Apr. 27, 2004 (JP) 2004-131567
Apr. 28, 2004 (JP) 2004-132814
Apr. 28, 2004 (JP) 2004-133088
Apr. 30, 2004 (JP) 2004-135025
Apr. 30, 2004 (JP) 2004-135039

(51) Int. Cl. B60C 17/00; B29D 30/02

(52) U.S. Cl. 156/112; 152/158

(57) ABSTRACT

A run flat tire support body, a method of manufacturing the run flat tire support body, and a run flat tire on which the run flat tire support body is fixedly mounted. The run flat tire support body (14) enabling a reduction in weight and the suppression of the wear of the outer surface thereof by the sliding thereof on the inner surface of a tire when the tire runs in a run flat state comprises a base material part (13) having an inner diameter allowing the support body to be fitted to a rim (16) and formed of a resin foam body of 0.3 to 0.9 g/cm³ in density, a reinforcement part (15) installed on the inner peripheral part of the base material part (13), and a non-foam resin outer layer (11) covering at least the outer peripheral surface of the base material part (13).

### TECHNICAL FIELD

The invention relates to; a run-flat tire support mounted to a rim of a pneumatic tire for an automobile, capable of maintaining a necessary outer tire diameter to thereby enable it to be safely drivable in a case where the tire went flat; a manufacturing method therefor; and a run-flat tire with the run-flat tire support fixedly mounted thereto.

### BACKGROUND ART

In a state where an air pressure in a tire is reduced greatly or down to zero due to a puncture of the tire or some other reason (referred to as a run-flat state), a run-flat tire is imparted with a durability that the tire can endure a load and driving of a vehicle till the vehicle reaches the nearest gas station. As run-flat tires, two types have been put into practice, one of which is a side reinforcement type having reinforced side portions and the other of which is a core type having a run-flat tire support (hereinafter also referred to as simply a support) is provided inside the tire.

As run-flat tire supports, there have been known a non-foam support using a polyurethane elastomer with a tensile modulus at 80° C. in the range of from 20 to 60 MPa (the following Patent Literatures 1 and 2) and a support fabricated with a flexible non-foam elastomer (the following Patent Literature 3).

The supports described in the following Patent Literatures 1 to 3, however, has a limitation in reduction in weight since any of the supports are made from a non-foam, thereby disabling a request for decrease in fuel consumption by weight reduction of the whole of a vehicle to be coped with sufficiently. If a run-flat tire mounted with a support formed with a resin foam, with which it is thought to form a support for reduction in weight, is driven in a run-flat state, that is in a state where a support holds a vehicle in position, it has been found that the surface of the support and the inner surface of the tire vigorously slides relatively each other, leading to a problem of a rapid wear of the support.

Patent Literature 1: WO 01/42000 A1

Patent Literature 2: JP 10-6721 A

Patent Literature 3: US 2003/0000623 A1

### DISCLOSURE OF THE INVENTION

### Problem to be Solved by the Invention

It is an object of the invention to provide a run-flat tire support capable of more of reduction in weight, suppressing a wear on a surface of the support due to relative slide between the inner surface of a tire and the surface of the support during driving in a run flat state, a manufacturing method therefor, and a run-flat tire with the run-flat tire support fixedly mounted thereto.

### Means for Solving the Problems

The object can be achieved by the invention having the following structure. That is, a run-flat tire support of the invention is a run-flat tire support mounted to a rim and includes: a base section made from a resin foam with a density in the range of from 0.3 to 0.9 g/cm³; a reinforcement section provided on the inner peripheral portion of the base section; and a non-foam resin outer layer covering a contact surface of the base section with the inner surface of the tire during driving in a run-flat state. Such a run-flat support has become possible to achieve lightness than conventional and suppress a wear of the surface of the support due to a slide thereof on the inner surface of a tire during driving in a run-flat state.

The non-foam resin outer layer may be made either from a resin different from the base section or from the same resin as the base section. A thickness of the non-foam resin outer layer has only to be a value by which a necessary driving distance is secured in a run-flat state and no specific limitation is placed thereon, but a thickness thereof is preferably in the range of 0.01 to 3 mm. If a thickness of a non-foam resin outer layer is excessively small, a slight wear of the layer causes the base section to slide the inner surface of a tire, while a thickness thereof is excessively large, a request for reduction in weight of the support cannot be satisfied. Portions not in contact with the inner surface of a tire in a run-flat state at the sides of the base section are preferably not made from a non-foam resin layer since a more of reduction in weight of the support is realized.

In a case where a density of a resin foam from which a base section is made is less than 0.3 g/cm³, a mechanical strength sometime decreases, while a density thereof exceeds 0.9 g/cm³, an effect of reduction in weight is not sufficient. A density of a resin foam is preferably in the range of 0.4 to 0.7 g/cm³ from the fact that a strength and reduction in weight is excellent in a balance therebetween. A resin foam from which a base section is made preferably has a 5% offset stress in the range of from 0.3 to 3 MPa. If a 5% offset stress is less than 0.3 MPa, a load withstanding property during driving in a run-flat state is not sufficient, while if a 5% offset stress exceeds 3 MPa, a base section is excessively hard, leading to difficulty in mounting it to a tire and vibrations during driving in a run-flat state is problematically large. An offset stress is obtained in a compression test (see “Plastic Testing Handbook” edited by Plastic Standard Testing Method Research Organization and published by Nikkan Kogyo Newspaper Co., Ltd. pp. 71 and 72).

In the run-flat tire support, the resin foam is preferably a closed cell polyurethane resin foam with an average cell diameter in the range of from 20 to 200 μm. Such a run-flat tire support is a support that is especially light in weight of resin foams and excellent in mechanical strength, elasticity and the like.

In the run-flat tire support, the base section preferably has plural recesses on the side surfaces thereof. Such a run-flat tire support has a necessary strength and at the same time, smaller in weight.

In the run-flat tire support, the reinforcement section is preferably constituted of reinforcement fibers and a non-foam resin. With such a construction adopted, the run-flat tire support can be fixed to a rim with a necessary strength and firmly mounted while preventing a slip between the rim and the support.

In the run-flat tire support, it is preferable that the base section is made from a closed cell resin foam, the reinforcement section is constituted of a resin layer and a cord layer including a cord wound in the tire circumferential direction formed in the resin layer and grooves are formed in a direction perpendicular to the tire circumferential direction on the inner peripheral surface of the resin layer.

The run-flat tire support with such a construction has a reinforcement section with a cord layer provided in a rim mounting portion, deformation due to a centrifugal force during an ordinary driving is suppressed to thereby obtain a stable engagement strength with a rim. Beside, grooves extending in a direction perpendicular to the tire circumferential direction are formed on the inner peripheral surface which the reinforcement section has, which increases the inner diameter of the support with ease. As a result, even unless the outer peripheral surface of a support mounting portion of the rim coincides in profile with the inner peripheral surface of the support to a high precision, the support can be fixedly mounted on the rim with ease. With the grooves formed, it can also contribute to reduction in weight of the support.

In the run-flat tire support, it is preferable that plural grooves not only extend in the width direction of the reinforcement layer, but are also formed at a predetermined pitch in the tire circumferential direction. According to such a run-flat tire support, the inner diameter of the support is uniformly enlarged along the tire circumferential direction with ease, thereby enabling the support to be fixedly mounted to the rim with ease.

In the run-flat tire support, a closed cell resin foam from which the base section is made is preferably a closed cell polyurethane resin foam. Since the base section is made from a closed cell polyurethane resin foam, a run-flat tire support is lighter in weight and can be formed so as to be more excellent in strength and durability than conventional.

A manufacturing method for a run-flat tire support of the invention is a manufacturing method for an annular run-flat tire support mounted to a rim in a run-flat tire, the run-flat tire support including: a base section made from a closed cell resin foam; a non-foam resin outer layer provided on the outer peripheral surface side of the base section; and a reinforcement section provided on the inner peripheral surface side of the base section, wherein a process for forming the reinforcement section includes: a cord layer forming step of winding a cord along the tire circumferential direction on the outer peripheral surface of an inner mold, which has protrusions extending in a direction perpendicular to the tire circumpherential direction on the outer peripheral surface thereof and which forms a rim mounting surface of the run-flat tire support thereon; and a resin layer forming step of forming a resin layer with a resin forming material supplied into the cord layer obtained by winding the cord.

According to a manufacturing method for such a run-flat tire support, the cord constituting the cord layer is wound around the inner mold on the outer peripheral surfaces of the protrusions and a resin forming material is supplied into the cord layer to thereby enable grooves corresponding to the protrusions to be formed on the inner peripheral surface of the resin layer while the cord layer is formed in the resin layer. With such operations applied, a support easy to enlarge the inner diameter can be fabricated and the support can be fixedly mounted to the rim with ease and firmness even if the outer peripheral surface of a support mounting section of the rim does not coincide in surface profile with the inner peripheral surface of the support with high precision.

In the run-flat tire support, it is preferable that not only is the outer side reinforcement fiber layer provided in the inner peripheral side of the non-foam resin outer layer, but the inner reinforcement fiber layer is also provided in the reinforcement section. With the construction adopted, even if a large centrifugal force is continuously exerted on the tire during driving for a long time, not only can deformation in the base section be firmly suppressed, but also a slip between the rim and the support is prevented to thereby enable both to be sustained as a single piece by a collaborative action of the reinforcement fiber layers between which the base section are sandwiched from the inner and outer peripheral sides, thereby enabling a run-flat tire support excellent in durability to obtained. As a result, a run-flat tire support can be provided that has a firmer structure and more of excellency in durability as compared with a conventional technique.

In the run-flat tire support, it is preferable that the reinforcement section is made from a non-foam resin and the inner side reinforcement fiber layer is embedded inside the reinforcement section. With such a construction adopted, more of reduction in weight can be achieved and a wear of the surface of a support caused by a slide between the surface thereof and the inner surface of a tire during driving in a run-flat state can be suppressed more as compared with a conventional technique.

In the run-flat tire support, the resin foam is preferably a closed cell polyurethane resin foam with an average cell diameter in the range of from 20 to 200 μm. Such a run-flat tire support is a support that is especially light in weight of resin foams and excellent in mechanical strength, elasticity and the like.

In the run-flat tire support, the base section preferably has plural recesses on the side surfaces thereof. Such a run-flat tire support has a necessary strength and at the same time, smaller in weight.

In the run-flat tire support, many of grooves are preferably formed on the surface of the non-foam resin outer layer. With the construction adopted as well, the support can be less in weight while a necessary strength is sustained.

In the run-flat tire support, it is preferable that the base section is made from a closed cell resin foam and the reinforcement section includes: a non-foam resin and a composite reinforcement fiber layer constituted of a fiber layer on the rim side formed in the non-foam resin and a cord layer wound around the outer side of the fiber layer in the circumferential direction of the rim. Since a run-flat support with such a construction can reduce a stiffness of the rim mounting portion of the support, the support can easily and firmly mounted and fixed to a rim even if the outer peripheral surface of the rim in the support mounting section thereof and the inner peripheral surface of the support does not coincide in surface profile with each other with high precision and furthermore, an effect can be enjoyed that even a run-flat tire support having a portion different in diameter from the other in a rim mounting portion thereof can be ensured so as to have a stable engagement fixing strength.

In the run-flat tire support, a winding tension in the cord layer is preferably higher than a winding tension in the fiber layer. Since a run-flat tire support with such a construction has a smaller tension in the fiber layer of the reinforcement layer in a portion in contact with the rim and the non-foam resin has elasticity, a degree of freedom is high in engagement with the rim. Additionally a winding tension of the cord on the outside of the fiber layer is higher, effects are obtained that engagement fixing to the rim can be firmer and displacement of the support is harder to occur even if a centrifugal force during ordinary driving is exerted or even if a load due to driving in a flat tire state is imposed. Since, even if the inner mold forming a composite reinforcement fiber layer has a portion different in diameter from the other, the cord is wound with a relatively higher tension than the fiber layer after the fiber layer is wound around the inner mold with a lower tension, the fiber layer exerts a slide proof action to thereby suppress displacement due to a slide of the cord on the surface of the mold as compared with a case where the cord is wound directly on the inner mold, which controls a cord spacing as being set and forms the run-flat tire support having a stabler engagement strength with the rim.

In the run-flat tire support, a closed cell resin foam from which the base section is made is preferably a closed cell polyurethane resin foam. Since the base section is made from a closed cell polyurethane resin foam, a run-flat tire support is lighter in weight and can be formed so as to be more excellent in strength and durability than conventional.

A manufacturing method for a run-flat tire support of the invention is a manufacturing method for a run-flat tire support mounted to a rim of a run-flat tire, the run-flat tire support including: a base section made from a closed cell resin foam; a reinforcement section provided on the rim mounting side of the base section; and a non-foam resin outer layer provided on the outer peripheral surface side of the base section facing the inner surface of the tire, wherein a process for forming the reinforcement section includes: a fiber layer winding step of winding a fiber layer forming material around the outer peripheral surface of the inner mold forming a rim mounting surface of the run-flat tire support; a cord layer winding step of winding a cord layer around the outer side of the fiber layer with a tension stronger than in the fiber layer winding step; and a reinforcement forming step of forming the reinforcement section by supplying a non-foam resin forming material to a composite reinforcement fiber layer constituted of the fiber layer and the cord layer to cause the non-foam resin forming material to be reaction-cured.

With such a manufacturing method adopted, the support can easily and firmly mounted and fixed to a rim even if the outer peripheral surface of a support mounting section of the rim and the inner peripheral surface of the support does not coincide with surface profile with each other with high precision, and furthermore, even in a case where a run-flat tire support has a portion different in diameter from the other, a stable engagement fixing strength is ensured without increasing the inner diameter of the support by the action of a centrifugal force during driving, therefore, enabling a run-flat tire support which does not cause a displacement to be manufactured.

In a case where the run-flat tire support is engagement-mounted to the rim, it is a preferable embodiment to interpose an endless belt-like fixing member between the rim and the run-flat tire support as a spacer, which enables the run-flat tire support to be fixedly mounted with stability even if there arise fluctuations in inner diameter of the run-flat tire support due to cure shrinkage thereof.

A manufacturing method for a run-flat tire support of the invention is a manufacturing method for a run-flat tire support mounted to a rim of a run-flat tire, using a mold constituted of an inner mold forming a rim mounting surface; an outer mold forming the outer peripheral surface facing the inner diameter of the tire; and a first lateral mold and a second lateral mold forming side surfaces, including: a reinforcement fiber layer forming step of forming a reinforcement fiber layer on the outer periphery of the inner mold; a non-foam resin outer layer forming step of forming a film of a non-foam resin forming raw material on the inner peripheral surface of the outer mold; a reinforcement section forming step of forming a reinforcement section having a rim mounting surface by coating the non-foam resin forming raw material on the reinforcement fiber layer; a resin foam raw material supply step of supplying a closed cell resin foam raw material which forms a base section in a cavity formed with the non-foam resin outer layer, the reinforcement section, the first lateral mold and the second lateral mold; and a curing step.

A manufacturing method with such a construction enables more of reduction in weight as compared with a conventional technique, and since the inner mold is used all through formation of the reinforcement fiber layer, formation of the reinforcement section and formation of the whole of the support, the inner peripheral surface of the rim mounting section of the support is controlled by the inner mold to thereby suppress fluctuations in dimensions of the reinforcement section having the reinforcement fiber layer, with the result that the run-flat support is imparted a stable mounting strength to the rim and can be manufactured at a low cost because of the use of one set of molds. Besides, since the non-foam resin outer layer, the base section and the reinforcement section can be manufactured with one set of molds, effects can also be ensured that a manufacturing method is simple and convenient and interlayer adhesion between the non-foam resin outer layer, the base section and the reinforcement section can be effected with firmness.

If a method described in Patent Literature 3 is adopted in which a resin raw material is coated on a cord with an applicator or the like and simultaneously the cord is wound on a mandrel, a problem occurs that if the resin raw material is reaction-curable, a change in viscosity of the raw material or gelation occurs in the applicator, or alternatively, a problem occurs that if a resin raw material is a solution, the reinforcement section has to be dried, whereas according to the invention, such problems can be avoided.

In the manufacturing method for a run-flat tire support, a closed cell resin foam from which the base section is made is preferably a closed cell polyurethane resin foam. A base section made from a closed cell polyurethane resin foam can manufacture a run-flat tire support lighter in weight, more excellent in strength and durability than conventional.

In the manufacturing method for a run-flat tire support, a non-foam resin from which the non-foam resin outer layer is made and a non-foam resin from which the reinforcement section is made are preferably both a reaction-curable polyurethane resin. A reaction curable polyurethane resin can manufacture a run-flat tire support excellent in strength, flexibility, wear resistance and adherence to a reinforcement fiber and besides, excellent in durability.

In the manufacturing method for a run-flat tire support, plural recesses are preferably formed at least one side surface of the base section. With such a construction, a run-flat tire support reduced in weight while a necessary strength is kept can be manufactured, which is effective for reduction in weight of the whole of a run-flat tire.

A feature of a run-flat tire of the invention is that one of the run-flat tire supports is mounted thereto. Such a run-flat tire is light in weight and a wear on the surface of the support due to a slide between it and the inner surface of the tire is suppressed during driving in a run-flat state.

In the run-flat tire, a lubricant with a low swellability is preferably applied to at least one of the inner surface of a tire and the outer peripheral surface of the run-flat tire support, the lubricant being low in swellability both on a rubber material from which the inner surface of a tire is made and on a material from which the outer peripheral surface of the run-flat tire support is made. Coating with a lubricant enables a driving distance in a run-flat state to be extended. The term “low swellability” means a low swelling degree, or a swelling at a level at which no reduction occur in strength of a material, and no swelling is preferable.

In the run-flat tire support, a preferable embodiment of the non-foam resin outer layer is to further contain a lubricant encapsulating microcapsule. With such a construction, a lubricant such as silicone oil or glycerin is supplied onto the surface of the support when the surface of a support is worn away by friction between the inner surface of the tire and the surface of the support, which effectively suppresses a wear on the surface of the support. A non-foam resin outer layer may be either of a monolayer structure, or of a two layer structure constituted of a lubricant encapsulating microcapsule layer as the outermost layer and a layer as an underlying layer thereof not including a lubricant encapsulating microcapsule.

### BRIEF DESCRIPTION OF DRAWINGS

FIG. 1 is a perspective sectional view showing a structure of a run-flat tire related to the first embodiment.

FIG. 2 is a sectional view taken on line X1 to X1 of FIG. 1.

FIG. 3 is a perspective view of another run-flat tire support.

FIG. 4 is a sectional view taken on line Y1 to Y1 of FIG. 3.

FIG. 5 is a plan view and a sectional view showing a run-flat tire support having recesses on the side portions.

FIG. 6 is a perspective sectional view showing a structure of a run-flat tire related to the second embodiment.

FIG. 7 is a perspective view showing a run-flat tire support.

FIG. 8 is a sectional view taken on line Y2 to Y2 of FIG. 7.

FIG. 9 is a side view of a run-flat tire support.

FIG. 10 is a plan view and a sectional view showing a run-flat tire support having recesses on the side portions.

FIG. 11 is a view showing an example of apparatus for forming a reinforcement section.

FIG. 12 is an enlarged side view of a cord layer immediately after forming.

FIG. 13 is a schematic sectional view showing an assembly step of a run-flat tire.

FIG. 14 is a perspective sectional view showing a structure of a run-flat tire related to the third embodiment.

FIG. 15 is a sectional view taken on line X3 to X3 of FIG. 14.

FIG. 16 is a perspective view of another run-flat tire support.

FIG. 17 is a sectional view taken on line Y3 to Y3 of FIG. 16.

FIG. 18 is a view showing another run-flat tire support mounted to a rim.

FIG. 19 is a perspective sectional view showing a structure of a run-flat tire related to the fourth embodiment.

FIG. 20 is a sectional view showing a run-flat tire having a run-flat tire support having a portion different in diameter from the other on the inner peripheral surface, fixedly mounted to a rim having a portion different in diameter from the other.

FIG. 21 is a perspective view showing a manufacturing step for a composite reinforcement fiber layer by winding a cord on a fiber layer.

FIG. 22 is a perspective view and a sectional view of another run-flat tire support.

FIG. 23 is a sectional view showing a manufacturing step for a run-flat tire support as an example.

FIG. 24 is a sectional view showing a manufacturing step for a run-flat tire support as an example.

FIG. 25 is a plan view of a first mold.

FIG. 26 is a view showing an example of run-flat tire using a single piece rim.

FIG. 27 is a view showing an example of run-flat tire using a single piece rim.

FIG. 28 is a view showing an example of run-flat tire using a split rim.

FIG. 29 is a view showing a step of forming a reinforcement layer on an inner mold.

### DESCRIPTION OF REFERENCE NUMERALS

10: run-flat tire

11: non-foam resin outer layer

12: tire

13: base section

14: run-flat tire support

15: reinforcement section

16: rim

18: reinforcement fiber layer

30: run-flat tire

32: run-flat tire support

36: base section

37: non-foam resin outer layer

38: reinforcement section

39: resin layer

40: cord layer

41: cord

42: groove

70: run-flat tire

71: non-foam resin outer layer

73: base section

74: run-flat tire support

75: reinforcement section

76: base section

77: outer side reinforcement fiber layer

78: inner side reinforcement fiber layer

100: run-flat tire

101: composite reinforcement fiber layer

102: run-flat tire support

103: fiber layer

104: non-foam resin outer layer

105: cord layer

106: base section

108: reinforcement section

141: first mold

142: second lateral mold

143: inner mold

144: outer mold

145: rotary shaft

146: first lateral mold

### BEST MODE FOR CARRYING OUT THE INVENTION

### FIRST EMBODIMENT

Description will be given of the first embodiment of the invention with reference to the accompanying drawing. A run-flat tire support of the embodiment includes: a base section made from a resin foam with a density in the range of from 0.3 to 0.9 g/cm³; a reinforcement section provided in the inner peripheral portion of the base section; and a non-foam resin outer layer covering a contact surface of the base section with the inner surface of a tire during driving in a run-flat state.

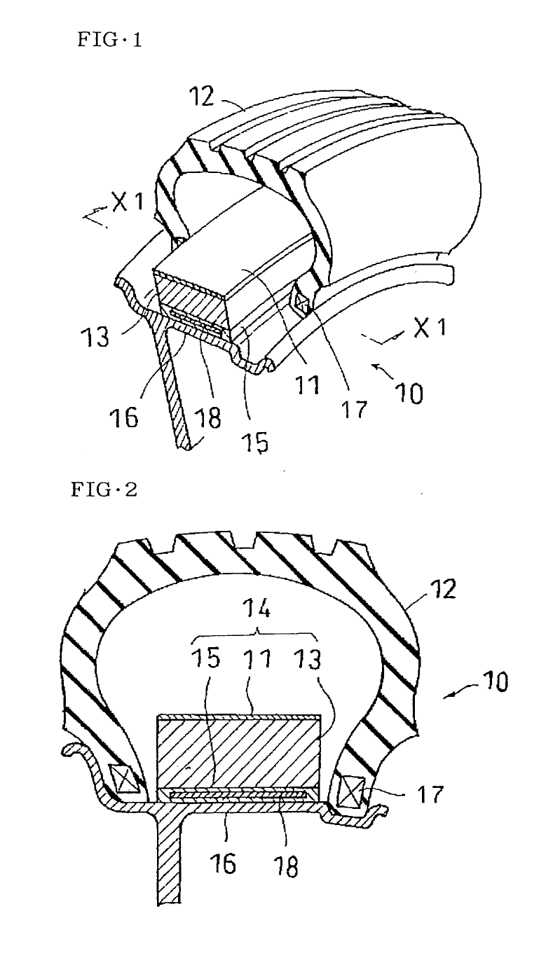

FIG. 1 is a perspective sectional view showing a structure of a run-flat tire related to the first embodiment. FIG. 2 is a section taken on line X1 to X1 of FIG. 1. A run-flat tire 10 is constituted of a tire 12 fixedly mounted to a rim 16 and an annular run-flat tire support 14. A shape of the support 14 is smaller than an inner space of the tire 12. The rim 16 is a single piece rim formed so that the bead 17 side on the right side of the figure is formed to be equal to or less than the inner diameter of the support 14. Hence, the tire 12 has a bilaterally asymmetrical sectional shape.

The support 14, which is a core, has a section in the shape of a rectangle and is outer engagement-mounted on a central flat portion (a support mounting portion) of the rim 16. The support 14 includes: a base section 13 made from a resin foam; a reinforcement section 15 provided on the inner peripheral portion (rim mounting portion) of the base section 13 in contact with the central flat portion of the rim 16; and a non-foam resin outer layer 11 provided in the outer peripheral portion of the base section 13 facing the inner surface of the tire. The non-foam resin layer 11 covers a contact surface with the inner surface of the tire during driving in a run-flat state and may extend over to the side portions of the base section 13 for a safety concern. A reinforcement fiber layer 18 is provided in the reinforcement section 15 in order to prevent the support from rising up and moving due to increase in diameter of the support under an influence of a centrifugal force on the support during driving in an ordinary state, not in a run-flat state. A sectional shape of the support 14 is not specifically limited, but the shape is preferably a flat shape longer in the tire width direction in consideration of stability during driving in a run-flat state.

The rim 16 shown in FIG. 2 as an example is of a single-piece type, but a split rim is preferably used as a preferable embodiment. Since a two-piece rim is generally used, it is less costly to an advantage as compared with the rim shown in FIG. 2 in a specific shape. A structure of a rim to which a run-flat tire of the invention is mounted is not specifically limited and it is possible to use a three-piece rim (3P rim) including another different member in addition to a single-piece rim as shown in FIG. 2 and a two-piece rim.

The support 14 shown in FIG. 2 is rectangular, on which no limitation is imposed and a shape of the inner diameter side is also selected so as to be of a shape in which no cracking occurs even by compression deformation, which is a preferable embodiment. Plural grooves or recesses are preferably formed on the outer peripheral surface of the non-foam resin outer layer 11 from the view point of reduction in weight of the whole of the support.

Any of resin foams from each of which the base section 13 is made can be used in the support 14 without specific limitation as far as it has characteristics required as the support 14. It is preferable to use a vulcanized rubber foam and a polyurethane resin foam, which are both a thermoset material, especially in consideration of flexibility, elasticity and the like.

A resin foam can be produced by means of one of known methods. To be concrete, known molding methods are as follows: a molding method in which a chemical foaming agent generating a gas due to heat decomposition or a foaming agent forming a foam by gasification is added into a resin or a resin forming raw material to obtain a foam in a predetermined shape, and a molding method in which a resin forming raw material is mixed by agitation with a foaming agent or a non-reactive gas and transformed into a foam (a cell dispersion liquid), followed by curing into a predetermined shape.

Preferable examples of rubber material from which vulcanized rubber foam is made includes: natural rubber, isoprene rubber, styrene-butadiene rubber, butadiene rubber, ethylene propylene rubber, chloroprene rubber, mirable urethane rubber and the like.

Various kinds of known rubber additive agents are added into a vulcanized rubber foam when required as follows: reinforcement agents such as carbon black and silica; a process oil; a plasticizer; a processing aid; a filler; an antidegradant; and the like in addition to a foaming agent, a vulcanization accelerator, and vulcanizer. A vulcanized rubber foam can be molded with an ordinary method. That is, a rubber material, carbon black and a process oil are kneaded using a Banbury mixer or the like to obtain a master batch, then, a foaming agent, a vulcanizer and a vulcanization accelerator are added into the master batch after cooled down to knead the mixture with a kneader or the like and to obtain a reactive rubber composition. The reactive rubber composition is fed into a mold in a predetermined shape and heated to thereby foam-cure the composition and to form a base section of a run-flat tire support.

A foaming agent for producing a vulcanized rubber foam is a known chemical foaming agent, which is a compound that decomposes by heating to generate a gas. Examples of the known chemical foaming agent include: inorganic foaming agent such as sodium bicarbonate and ammonium bicarbonate; nitroso compounds such as N,N′-dinitrosopentamethylenetetramine; azo compounds such as azodicarbonamide and azobisisobutylonitrile; sulfonylhydrazides such as benzenesulfonylhydrazide and toluenesulfonylhydrazide; and p-toluenesulfonylsemicarbazide. It is preferable to use salicylic acid, urea, and a foaming assistant containing one or two thereof together with a foaming agent described above.

A polyurethane resin foam is constituted of hollow spherical particles and a polyurethane elastomer or made from a polyurethane elastomer foamed with a foaming agent. Polyurethane elastomers each can be transformed to a foam using a known polyurethane elastomer forming raw material, wherein polyurethane elastomer forming raw materials are a polyol compound, a polyisocyanate compound and a chain extender, all of which are known in the technical field of a polyurethane elastomer (see Keiji IWATA, “Polyurethane Hand Book” edited by Nikkan Kogyo Shimbun Ltd., published on Sep. 25, 1987).

A polyurethane elastomer can be produced by a one shot method or a prepolymer method, whichever may be used, but preferable is a prepolymer method since an elastomer excellent in physical properties such as mechanical strength can be obtained even from the same raw material. As production methods for a polyurethane foam, the following methods can be exemplified:

(1) A method in which a prepolymer or a mixture of a prepolymer and a chain extender is agitated so as to include a non-reactive gas to obtain a meringue-like cell dispersion liquid and in a case where a prepolymer is adopted, a chain extender is further added and mixed into the liquid and a mixture of the prepolymer and a chain extender is supplied as it is into a mold in a predetermined mold to reaction-cure the mixture in the mold.

(2) A method in which a foaming agent is added into a polyurethane elastomer raw material composition in a liquid state and the mixture is fed into a mold to foam and cure the mixture by gasifying a foaming agent simultaneously with a reaction.

(3) A method in which hollow spherical particles are added and dispersed into a polyurethane elastomer forming raw material composition and then, the mixture is fed into a mold and cured therein.

According to the production method (1), there arises an effect that a base section uniform in cell diameter and density can be obtained. A non-reactive gas is preferably air because of good stability in shape. In preparation of a cell dispersion liquid, a content of a known surfactant in the technical field of polyurethane foam is preferably in the range of from 0.5 to 20 wt % and more preferably in the range of from 1 to 10 wt % relative to all the quantity of a polyurethane resin.

In the production method (2), examples of foaming agents for a polyurethane elastomer include: pentane, a fluoroalkyl compound and water. Water itself is not gasified and reacts with an isocyanate group to generate carbon dioxide, which works as a forming agent. In production of a polyurethane foam, a surfactant is preferably used because of formation of uniform, fine cells.

In the production method (3), hollow spherical particles are preferably hollow thermoplastic resin balloons. Such hollow thermoplastic resin balloons can be obtained, for example, by using a thermoplastic resin such as a polyacrylonitrile or a polyvinylidene chloride and heating microcapsule containing an organic solvent such as hydrocarbon therein. Commercially available products on the market are EXPANCEL (manufactured by Nippon Ferrite Co., Ltd.), MICROPEARL (manufactured by Matsumoto Yushi K.K.) and the like.

In a case where hollow spherical particles are dispersed into a polyurethane elastomer forming raw composition in a liquid state, one of the following agitation apparatuses are used, such as a mixing apparatus constructed in a way such that a ribbon-like agitation vanes are fixed at the ends of plural horizontal arms attached to an agitation shaft in a way of a helix relative to the agitation shaft (for example, manufactured by Satake Kagaku Kikai K.K.) or a mixing apparatus in which an agitation vessel is rotated about a rotary shaft as a central fixed point and revolved around a central fixed point outside the rotary shaft in high speeds (for example, a super mixer manufactured by Shinky Co., Ltd.) to thereby effectively enable the contents in the apparatus to be mixed while cells are included, and separation of hollow spherical particles and a polyurethane elastomer raw material composition (floatation separation of hollow spherical particles) is suppressed.

A base section 13 constituting a run-flat tire support 14 is made from a resin foam in the range of from 0.3 to 0.9 g/cm³ in density and preferably made from a closed cell polyurethane resin foam in the range of from 20 to 200 μm in average cell diameter.

As a non-foam resin forming a non-foam resin outer layer 11 of a run-flat tire support 14, no specific limitation is imposed on a material as far as the material has a necessary flexibility and a strength. Concrete examples thereof include: polyester resins such as polyethylene terephthalate and a polybutylene naphthalate; polyamide resins such as Nylon 6 and Nylon 66; a polyurethane resin; fluororesins such as PFA and ETFA; a polycarbonate resin; and a polyacetal resin.

As methods for stacking the non-foam resin on the outer peripheral portion of a base section, the following methods are exemplified:

(1) A method in which a non-foam resin outer layer member is formed with a non-foam resin and the non-foam resin outer layer member and a base section molded in advance are adhered to each other with an adhesive.

(2) A method in which a non-foam resin outer layer member is molded with a non-foam resin as a thermoshrinkable film in the shape of a cylinder and the member is heat-shrunk on the outer peripheral surface of the base section molded in advance in company with coating of an adhesive thereon.

(3) A method in which a non-foam resin outer layer member molded in advance is placed in a mold and a resin foam forming raw material is injected into the mold and cured therein to form a base portion and simultaneously adhere the base section to the non-foam resin outer layer member.

(4) A method in which a cavity for molding a non-foam resin outer layer is formed with a mold in the outer peripheral portion of a base section molded in advance and a non-foam resin outer layer forming material is injected into the cavity to form a non-foam resin outer layer.

In the above description, in a case where a non-foam resin outer layer is molded in advance, the inner surface (an adhesion surface) is preferably applied with an adhesion treatment such as a corona discharge treatment, a plasma treatment and a blast treatment or a primer treatment, which is selected according to a resin from which the outer layer is made, in order to increase an adhesion strength.

In the embodiment, the reinforcement section 15 provided in a rim mounting portion of the base section 13 is constituted of reinforcement fibers and a non-foam resin. The non-foam resin form which the reinforcement section 15 is made is preferably a non-foam of a resin material from which the base section 13, thereby enabling a adhesion strength to be secured.

Any kind of known reinforcement fibers can be used without imposing a limitation thereon. Examples thereof include: polyamide fibers such as Nylon 6,6; polyester fibers such as a polyethylene terephthalate; an aramid fiber, a glass fiber; a steel cord; and the like. A reinforcement fiber may be either a monofilament or something like a piano wire. The reinforcement fibers are preferably used after an adhesion treatment for improvement on an adherence to a polyurethane foam. A reinforcement fiber may be used in a way that a thread or a monofilament is wound in the circumferential direction, or as a woven cloth or a net formed therefrom.

A reinforcement section can be formed in methods: in one of which a reinforcement section member obtained by molding reinforcement fibers and a non-foam resin in advance is placed in a mold, into which a resin foam forming raw material is injected, and then a resin foam is cured to mold a base section and at the same time, the base section is adhered to the reinforcement member, and in another of which a base section molded in advance and reinforcement fibers are placed in a mold, into which a non-foam resin forming raw material is injected to thereby reaction-cure the injected the raw material.

In a run-flat tire of the invention, a lubricant low in swellability is preferably coated on at least one of the inner surface of the tire, and the outer peripheral surface of a run-flat tire support in contact with the inner surface of the tire during driving in a run-flat state (the outer peripheral surface of the non-foam resin outer layer 11), wherein the lubricant being low in swellability both on the inner surface thereof and the outer peripheral surface thereof. As such a lubricant, glycerin or polyglycerin is exemplified as a preferable material thereof.

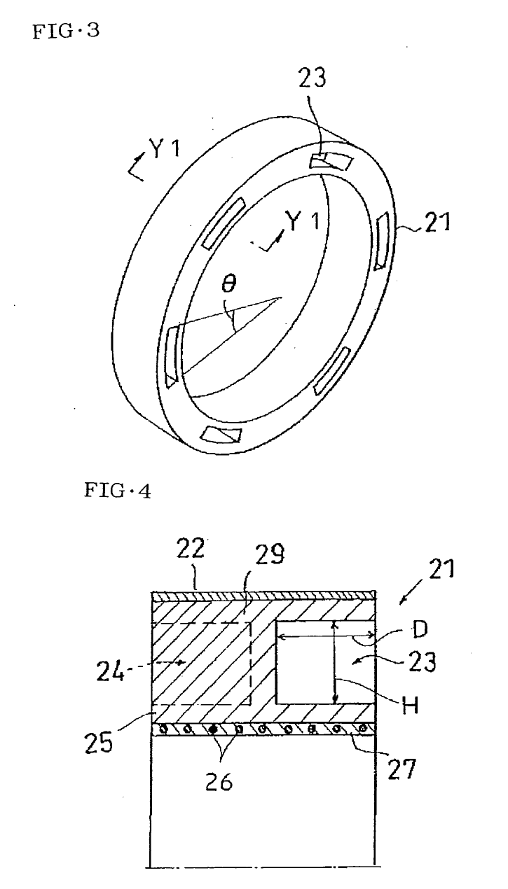

FIG. 3 is a perspective view of another run-flat tire support. FIG. 4 is a sectional view taken on line Y1 to Y1 of FIG. 3. The support 21 is constituted of the outer peripheral portion 29 and the inner peripheral portion 25, and recesses 23 and 24 are formed on the left and right sides for reduction in weight. A non-foam resin outer layer 22 is provided in the outermost layer of the outer peripheral portion 29. A reinforcement section 27 containing a reinforcement fiber layer 26 is provided in a similar to that shown in FIG. 2 on the inner peripheral surface of the inner peripheral portion 25 in contact with a rim. Formation positions of recesses 23 and 24 are not limited to the side portions but may be formed on the surface of the outer peripheral portion 29 in contact with the inner surface of a tread and may be provided both on the side portions and the outer peripheral portion 29.

The number and shapes of the recesses 23 and 24 are not specifically limited as far as requirements such as a predetermined mechanical strength is met. In FIGS. 3 and 4, there are shown an example of recesses each in the shape of a rectangular prism, on which no limitation is placed, and a semi-oval shape may be allowed, for example. With a larger volume percentage of recesses, the weight of the support 21 can be reduced. A volume of a recess in the shape of a rectangular prism as shown in FIGS. 3 and 4 is determined by a height H, a depth D and an angle θ corresponding to a length in the circumferential direction.

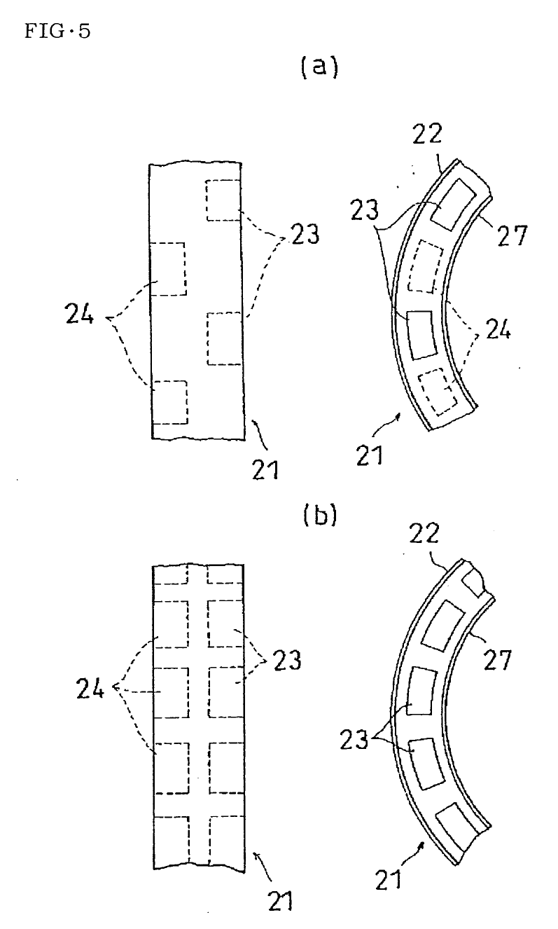

FIG. 5 shows examples of arrangement of recesses formed on side portions of the support 21 in side view and plan view. FIG. 5(a) is an example in which recesses 23 and 24 formed on both sides respectively are arranged alternately so as not to overlap each other in side view, which corresponds to those shown in FIGS. 3 and 4. FIG. 5(b) is an example in which recesses 23 and 24 formed on both sides respectively are arranged so as to superimpose one on another in side view. The structure shown in FIG. 5(b) has more recesses and therefore, a volume percentage of the recesses is more, resulting in a lighter support.

Then, concrete description is given of an example of manufacture of a run-flat tire support related to the embodiment.

### MANUFACTURE EXAMPLE 1 OF RUN-FLAT TIRE SUPPORT

### <1> Fabrication of Reinforcement Section Member

A net formed with glass fibers was wound on and around the outer peripheral surface of an inner cylinder of a mold for molding a reinforcement section which has a cylindrical cavity with dimensions of an inner diameter of 420 mm, an outer diameter of 426 mm and a depth of 110 mm, constituted of an inner cylinder with the same outer diameter as a rim to which a run-flat tire is mounted.

60.5 g of MOCA (manufactured by Ihara Chemical Co., Ltd.) in a molten state at 120° C. was added into 500 g of Adiprene L-100 (manufactured by Uniroyal Chemical Co., Ltd.), which was an isocyanate group-terminated prepolymer at 80° C., both components was mixed by agitation and thereafter, vacuum defoamed to thereby prepare a non-foam resin forming raw material.

The mold for the reinforcement section around which a glass net is wound was heated at 100° C., the non-foam resin forming raw material was injected into the cylindrical cavity and cured therein at 100° C. for 1 hr to thereby fabricate a reinforcement section member.

### <2> Fabrication of Base Section

The reinforcement member fabricated in the process <1> was mounted on the inner cylinder of a mold for molding the base section having a cylindrical cavity with dimensions of an outer diameter of 504 mm, an inner diameter of 420 mm and a depth of 110 mm, followed by heating at 100° C.

5000 g of Adiprene L-100 was heated at 80° C., into which 150 g of silicone surfactant SH-192 (manufactured by Toray Dow Corning Silicone Co., Ltd.) was added, and the mixture was agitated in a 20 L vessel in the air atmosphere using a biaxial agitator till a liquid volume increases twofold to thereby prepare a cell dispersion liquid in a meringue state. After a temperature of the cell dispersion liquid was adjusted at 50° C., 605 g of MOCA in a molten state at 120° C. was added to the cell dispersion liquid and mixed to uniformity to thereby prepare a resin foam forming raw material.

The obtained resin foam forming raw material was injected into the cylindrical cavity of the mold for the base section to which the reinforcement section member was mounted and heat-cured at 100° C. for 1 hr to thereby prepare the base section in the shape shown in FIG. 3 having the reinforcement section. A density of the base section was 0.6 g/cm³ and a 5% offset stress was 2.0 MPa.

### <3> Fabrication of Non-Foam Resin Outer Layer

A mold piece for forming the outer peripheral surface of the base section having the reinforcement section fabricated in the process <2> is demolded, a mold piece with dimensions of the outer diameter of 510 mm and the width (or depth) of 110 mm is, instead, assembled in place and a cylindrical cavity was formed on the outer peripheral surface of the base section having the reinforcement section. A polyurethane forming raw material obtained by mixing Adiprene L-100 and MOCA, which is the same components as those used in the process <1>, together was injected into the cavity to cure the raw material at 100° C. for 8 hr, to thereby prepare a non-foam resin outer layer and to thereby manufacture a run-flat tire support 1. The polyurethane resin from which the non-foam resin outer layer was made has a Shore A hardness of 90.

### MANUFACTURE EXAMPLE 2 OF RUN-FLAT TIRE SUPPORT

A run-flat tire support 2 was fabricated in a similar way to that in Manufacture Example 1 with the exception that a composition obtained by adding and mixing 128 g of MOCA into 500 g of Adiprene L-325 (manufactured by Uniroyal Chemical Co., Ltd.) as a raw material from which a non-foam resin outer layer was made was used. The polyurethane resin from which the non-foam resin outer layer had a Shore D hardness of 60.

### MANUFACTURE EXAMPLE 3 OF RUN-FLAT TIRE SUPPORT

A belt-like PET film with a thickness of 500 μm as a non-foam resin outer layer was corona discharge-treated on the inner surface thereof. The reinforcement section member fabricated in the <1> section of Manufacture Example 1 was mounted in the inner cylinder of a mold for a base section having a cylindrical cavity with dimensions of the outer diameter of 510 mm, the inner diameter of 420 mm and the depth of 110 mm. The belt-like PET film was adhered to the inner surface of a mold for molding the outer peripheral surface, the resin foam forming raw material of the section <2> of Manufacture Example 1 was injected into a remaining space of the cavity, the remaining space thereof was filled with the raw material and the raw material in the remaining space thereof was cured at 100° C. for 8 hr to thereby manufacture a run-flat tire support 3.

### MANUFACTURE EXAMPLE 4 OF RUN-FLAT TIRE SUPPORT

A run-flat tire support 4 was fabricated in a similar way to that in Manufacture Example 3 with the exception that a belt-like Nylon 6,6 with a thickness of 25 μm was used as a non-foam resin outer layer.

### MANUFACTURE EXAMPLE 5 OF RUN-FLAT TIRE SUPPORT

A run-flat tire support 5 was manufactured in a similar way to that in Manufacture Example 3 with the exception that a belt-like vulcanized SBR base rubber with a thickness of 3 mm and a Shore A hardness of 90 was used as a non-foam resin outer layer and a chloroprene rubber base adhesive was coated on the inner surface thereof.

### MANUFACTURE EXAMPLE 6 OF RUN-FLAT TIRE SUPPORT

A run-flat tire support 6 was manufactured in a procedure in which the resin foam forming raw material of the section <2> of Manufacture Example 1 was injected into a cavity of a mold for molding a base section having a cylindrical cavity with dimensions of the outer diameter of 510 mm, the inner diameter of 420 mm and the depth of 110 mm so that the cavity was filled with the raw material, the raw material in the cavity was cured at 100° C. for 8 hr to thereby, manufacture a run-flat tire support 6 without either a reinforcement section or a non-foam resin outer layer.

### MANUFACTURE EXAMPLE 7 OF RUN-FLAT TIRE SUPPORT

A run-flat tire support 7 was manufactured in a procedure in which the reinforcement section member fabricated in the section <1> of Manufacture Example 1 was mounted in an inner cylinder of a mold for molding a base section having a cylindrical cavity with dimensions of the outer diameter of 510 mm, the inner diameter of 420 mm and the depth of 110 mm, the resin foam forming raw material fabricated in the section <2> of Manufacture Example 1 was injected into a remaining space of the cavity so that the remaining space thereof was filled with the raw material, the raw material in the remaining space thereof was cured at 100° C. for 8 hr to thereby, manufacture a run-flat tire support 7 without a non-foam resin outer layer.

### MANUFACTURE EXAMPLE 8 OF RUN-FLAT TIRE SUPPORT

A run-flat tire support 8 was manufactured in a procedure in which the reinforcement section member fabricated in the section <1> of Manufacture Example 1 was mounted in an inner cylinder of a mold for molding a base section having a cylindrical cavity with dimensions of the outer diameter of 510 mm, the inner diameter of 420 mm and the depth of 110 mm, the non-foam resin outer layer forming raw material fabricated in the section <3> of Manufacture Example 1 was injected into a remaining space of the cavity so that the remaining space thereof was filled with the raw material, the raw material in the remaining space thereof was cured at 100° C. for 8 hr to thereby, manufacture a run-flat tire support 8 constituted of a base section and a non-foam resin outer layer, both formed with a non-foam polyurethane resin. A density of the base section was 1.05 g/cm³.

(Evaluation)

Evaluation was conducted on a weight of a run-flat tire support and durability in a run-flat state. Durability in a run-flat state was tested in the following way.

<Manufacture of Run-Flat Tire>

Polypropylene glycol was coated on the inner surface of a tire (235/45ZR/17) as a lubricant and a support was inserted into the inside of the tire. A 17 inch 3P rim was mounted to the tire and the tire was filled with air to an air predetermined pressure, beads are set at predetermined position, and thereafter, the air pressure was reduced to zero. The run-flat tire was subjected to a driving test in a run-flat test with a drum tester in conditions of a load of 400 kgf and a driving speed of 80 km/h. In a result of evaluation, a run-flat tire support was evaluated “good” if it endured over a 3-h continuous driving (a driving distance of 240 km). Results are shown in Table 1.

TABLE 1

| | Manufacture | Manufacture | Manufacture | Manufacture | Manufacture | Manufacture | Manufacture | Manufacture |
|---|---|---|---|---|---|---|---|---|
| | Example 1 | Example 2 | Example 3 | Example 4 | Example 5 | Example 6 | Example 7 | Example 8 |
| Run-flat | Support 1 | Support 2 | Support 3 | Support 4 | Support 5 | Support 6 | Support 7 | Support 8 |
| tire | | | | | | | | |
| supports | | | | | | | | |
| in use | | | | | | | | |
| Support | 3.0 kg | 3.0 kg | 2.7 kg | 2.7 kg | 3.1 kg | 2.4 kg | 2.7 kg | 4.2 kg |
| weights | | | | | | | | |
| Durability | Good | Good | Good | Good | Good | Stoppage | Stoppage | Good |
| | | | | | | after 0.5 h | after 0.8 h | |
| | | | | | | driving due | driving due | |
| | | | | | | to surface | to surface | |
| | | | | | | wear | wear | |

It is understood from the results that a run-flat tire support of the invention is light in weight, endurable to a wear caused by a slide between the support and the inner surface of the tire and has characteristics required as a run-flat tire support.

### SECOND EMBODIMENT

Then, description will be given of the second embodiment of the invention. A run-flat tire of the embodiment has a base section made from a closed cell resin foam and a reinforcement section thereof constituted of a resin layer and a cord layer formed in the resin layer with a cord wound in the tire circumferential direction, and further, has grooves extending in a direction perpendicular to the tire circumferential direction formed on the inner peripheral surface of the resin layer. Description of construction shared by the first embodiment such as a resin foam from which a base section is made and a non-foam resin from which a non-foam resin outer layer is made is omitted and description will be given mainly of different points therefrom.

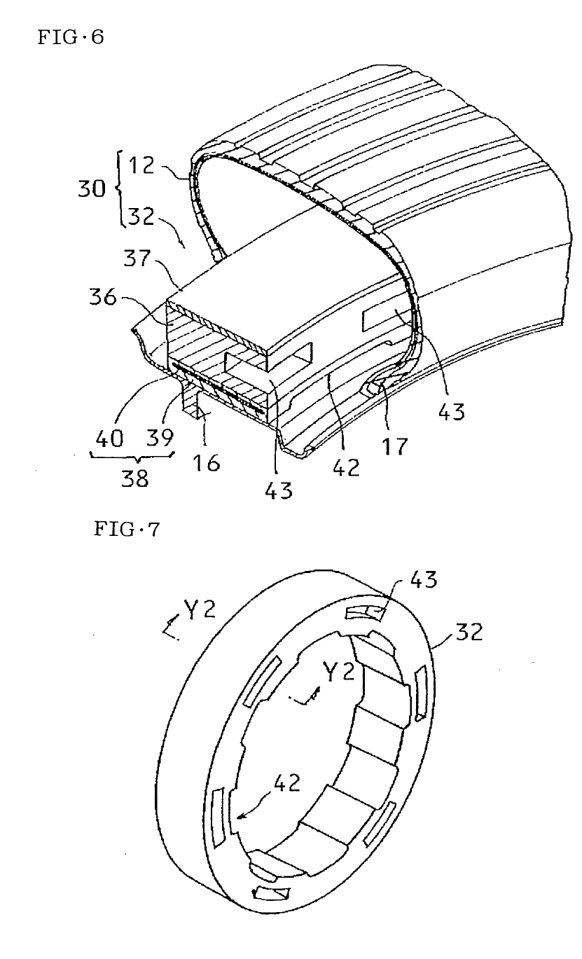

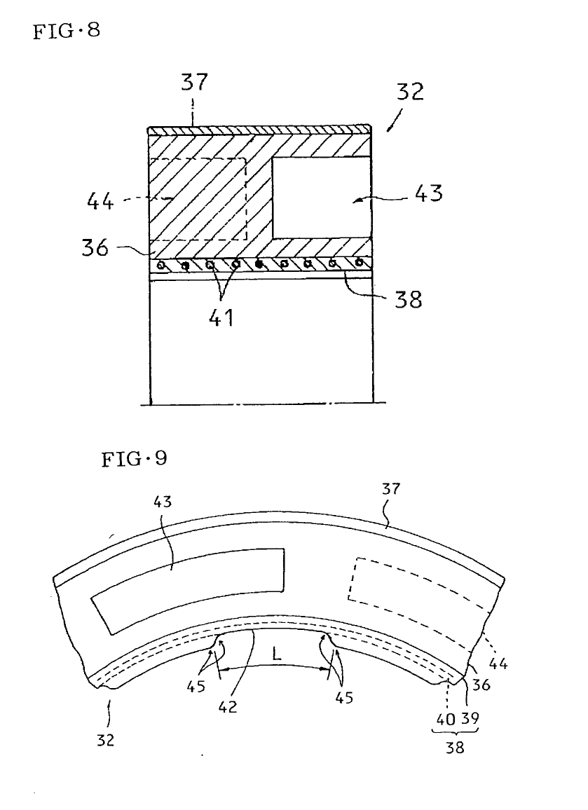

FIG. 6 is a perspective sectional view showing a structure of a run-flat tire related to the second embodiment. FIG. 7 is a perspective view showing a run-flat tire support. FIG. 8 is a sectional view taken on line Y2 to Y2 of FIG. 7. FIG. 9 is a side view of a run-flat tire support.

A run-flat tire support 32 includes: a base section 36 made from a closed cell resin foam; a non-foam resin outer layer 37 provided in the outer peripheral portion of the base section 36; and a reinforcement section 38 provided in the inner peripheral portion of the base section 36. In the embodiment, the reinforcement section 38 is constituted of: a resin layer 39; and a cord layer 40 formed in the resin layer 39. The cord layer 40 is formed with a cord 41 wound around in the tire circumferential direction and prevents the support 32 from rising up from the rim 16 by the action of a centrifugal force acting in ordinary driving.

The resin layer 39 may be made from either a foam resin or a non-foam resin. In a case where the resin layer is made from a foam resin, the foam resin is preferably a foam of a resin (resin foam) from which the base section is made. Thereby, the resin layer 39 and the base section 36 can be efficiently fabricated. The resin foam is as described above.

In a case where the resin layer 39 is made from a non-foam resin, the non-foam resin preferably has a 100% extension modulus in the range of from 2 to 20 MPa. If a 100% extension modulus of a non-foam resin is less than 2 Mpa, a resin (elastomer) is excessively soft to sometime render a fixing force to the rim insufficient. On the other hand, if a 100% extension modulus exceeds 20 MPa, engagement fixing to the rim is sometime difficult due to fluctuations in parameters of manufacture including cure shrinkage in a case where the inner diameter of the support is less than the outer diameter of the rim.

In a case where the resin layer 39 is made from a non-foam resin, the non-foam resin is preferably a non-foam of a resin from which the base section 36 is made. Thereby, an adhesion strength increases between the base section 36 and the reinforcement section 38. As such a non-foam resin, preferably used is an elastic epoxy resin or a curable polyurethane resin, of which the use of a polyurethane resin is preferable from the fact that polyurethane resin is more excellent in durability in dynamic deformation and more excellent in mechanical strength. A polyurethane resin can be produced by means of a one shot method or a prepolymer method, of which a prepolymer method is preferable to the other because of the reason described above. A polyurethane resin can be produced by mixing, for example, an isocyanate component such as an isocyanate polymer and an active hydrogen containing component together to thereby obtain a curable composition and to cure the curable composition.

Any of known cords can be used as the cord 41 of which the cord layer 40 is made without a limitation thereon. Examples thereof include: polyamide cords such as a rayon cord and a Nylon-6,6 cord; a polyester cords such as a polyethylene terephthalate cord; an aramid cord; a glass fiber cord; a kepler fiber cord, a carbon fiber cord and a steel cord, which are used either alone or in combination of two or more kinds.

Grooves 42 are formed in the width direction of the reinforcement section 38 on the inner peripheral surface of the resin layer 39 and in the embodiment, 8 grooves 42 are formed in the tire circumferential direction at a predetermined pitch. Thereby, the inner diameter of the support 32 is easy to increase and the support 32 can be mounted on the rim 16 with ease. Note that the grooves 42 has only to extend in a direction perpendicular to the tire circumferential direction, wherein the grooves 42 may extend either in a direction inclined relative to the width direction of the reinforcement section 38 or in the V letter pattern in plan view.

No specific limitation is imposed on a shape of a groove 42, but a groove 42 is preferably in the shape of almost a frustum in side view having the top side and bottom side in alignment with the circumferential direction. Thereby, durability while in a run-flat driving is preferably secured. Beside, corner portions 45 formed in the inner surface and an opening brim of a groove 42 are preferably chamfered or beveled. For example, a groove 42 with a depth of 1 mm is preferably applied with chamfering at corner portions 45 in the range of from 0.1 to 0.5 mm in radius. Thereby, a stress concentration while the support 32 is compression-deformed is prevented, thereby, enabling generation of cracks at corner portions 45 to be suppressed.

A size (a depth and a length L in the circumferential direction) of each of the grooves 42 and the number of the grooves 42 are not specifically limited as far as an effect of increase in the inner diameter of the support 32 can be preferably ensured and durability during run-flat driving can be secured, but a depth of a groove is preferably in the range of from 0.5 to 3 mm. If a depth thereof is less than 0.5 mm, not only is the weight of a support 32 heavier comparatively, but also an effect of increase in inner diameter of the support 32 is smaller and an effect of improvement on mountability decreases. On the other hand, if a depth thereof exceeds 3 mm, durability of the support 32 during run-flat driving has a chance to be hindered.

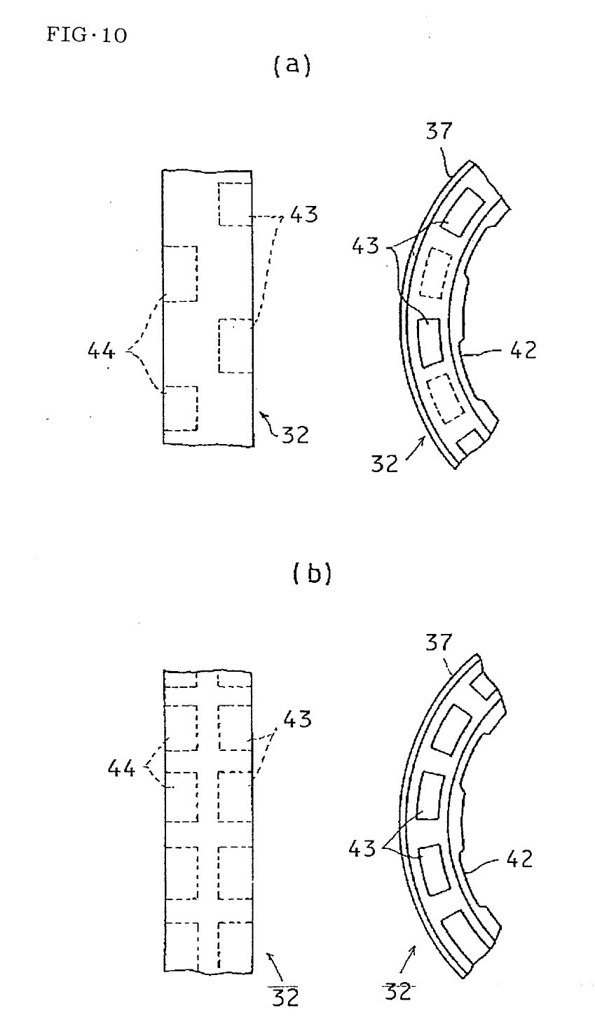

Plural recesses 43 and 44 are formed on the side portions of the base section 36. Thereby, a run-flat tire 30 can be reduced more in weight while a strength necessary for a run-flat tire support 32 is secured. FIG. 10 is views showing arrangement of recesses 43 and 44 formed on the side portions of the support 32 both in plan view and side view. FIG. 10(a) is an example of arrangement in which the recesses 43 and 44 are alternately provided so as not to overlap one another, which corresponds to the support shown in FIGS. 6 to 9. FIG. 10(b) is an example of arrangement of recesses 43 and 44 so as to be at the same position as each other in the circumferential direction. The support 32 of FIG. 10(b) is more in volume percentage of the recesses 43 and 44 and lighter in weight as compared with the support 32 shown in FIG. 10(a).

In the embodiment, the reinforcement section 38 is preferably constituted of: the resin layer 39; a fiber layer (not shown) formed in the resin layer 39; and the cord layer 40 obtained by winding a cord 41 on the outer periphery of the fiber layer in the tire circumferential direction. The fiber layer is preferably made from a woven cloth or a net. Any of known fiber materials from which the fiber layer is made can be used without a limitation thereon. Examples thereof include: rayon; polyamide fibers such as a Nylon 6,6 fiber; polyester fibers such as a polyethylene terephthalate fiber; an aramid fiber and a glass fiber.

In a case where a run-flat tire support has a rim mounting portion having a portion different in diameter from the other, a cord 41 is wound on the inner mold having the outer peripheral surface along a portion different in diameter from the other in fabrication of the support with a slide of the cord 41 on a slope of the portion different in diameter, having led to a problem that a cord spacing is not controlled so as to meet the setting to thereby cause fluctuations in engagement strength. According to the construction with the fiber layer, since the cord 41 is wound on the fiber layer after the fiber layer is wound on the inner mold, the fiber layer exerts an anti-sliding action. That is, movement of the cord 41 on the surface of the mold due to a slide is suppressed as compared with a case where the cord 41 is wound directly on the inner mold to thereby secure a cord spacing so as to be set and to exert a stable engagement strength on the rim 16.

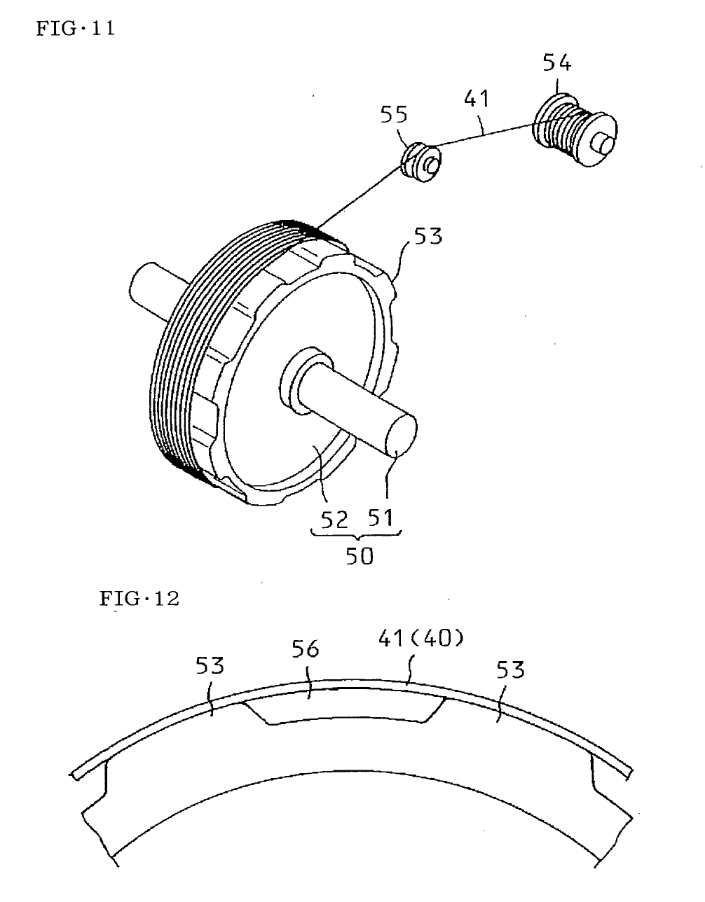

FIG. 11 is a view describing a manufacturing method for a run-flat tire support of the embodiment, wherein an example of apparatus for forming the reinforcement section is shown. FIG. 12 is an enlarged side view of the cord layer 40 directly after formation.

An inner mold 50 is prepared that forms a rim mounting surface of a run-flat tire support 32, that is the inner peripheral surface of a reinforcement section 38. The inner mold 50 includes: a rotary shaft 51; and a mold support 52, and is rotatable around the rotary shaft 51 as a central point. Protrusions 53 are formed on the outer peripheral surface of the inner mold 50 and in the embodiment, 8 protrusions 53 extends in the width direction of the reinforcement section 38. The protrusions 53 each assume the shape of almost a trapezoid in side view having chamfered corners and are provided so as to correspond to respective grooves 42 formed on the inner peripheral surface of the reinforcement section 38.

A cord 41 with which the cord layer 40 is formed has been taken up around a master roll bobbin 54 and supplies the cord 41 through a tension loading apparatus 55 so as to acquire a predetermined tension to wind the cord 41 on the outer peripheral surface of the inner mold 50 (corresponding to the cord layer forming step). The term “predetermined tension” used herein is preferably in the range of from 5 to 50 N (about 0.5 to about 5 kgf). If a tension is less than 5 N, cord arrangement is degraded in uniformity and a fixing force in engagement of the support 32 to the rim 16 is in a case not sufficiently exerted. On the other hand, if a tension exceeds 50 N, a case arises where the support 32 cannot be mounted on the rim 16 due to fluctuations in inner diameter of the support 32. Note that in a case where the cord 41 is a steel cord, a tension can be less than 5 N without any inconvenience.

The cord 41 is, as shown in FIG. 12, in a state being spanned between the protrusions 53 and spaces 56 are formed between the protrusions 53 on the inner peripheral side of the cord layer 40. The outer mold (not shown) for forming the reinforcement section is placed on the outer peripheral side of the inner mold 50, a resin forming raw material forming a resin layer 39 is injected into the outer mold to reaction-cure the resin forming raw material (corresponding to the resin layer forming step). The resin forming raw material is also injected into the spaces 56 formed on the inner peripheral surface side of arranged cord 41 (the cord layer 40) to form grooves 42 along the protrusions 53 while the cord layer 40 is almost surrounded therewith and the resin layer 39 is formed.

No specific limitation is placed on dimensions of each of the grooves 42 and the number of the grooves 42, but the parameters can be properly set in consideration of a formation step of the cord layer 40 and workability of the inner mold 50. If a height of the protrusions 53 is excessively high or the number of the protrusions 53 is excessively large, working of the inner mold 50 is unpreferably complicated. On the other hand, if a height of the protrusions 53 is excessively low or the number of the protrusions 53 is excessively small, the cord 41 wound around the inner mold 50 is brought into contact with the outer peripheral surface of the inner mold 50 between the protrusions 53 and it is not preferable since the spaces 56 are not formed in a proper way. The length L of a groove 42 can be set properly depending on the number of the grooves 42 to be formed and, for example, a length thereof is in the range of from 1/32 to 1/8 of the inner periphery of the support 32. The number of the grooves 42 is, for example, in the range of from 4 to 16.

To the formed reinforcement section 38, the base section 36, and the non-foam resin outer layer 37, are adhered to thereby form a run-flat tire support 32. The base section 36, can be adhered to the reinforcement section 38 simultaneously with molding the base section 36, in a procedure in which the formed reinforcement section is placed in a mold for molding the base section 36, without demolding the formed reinforcement section 38 from the inner mold 50 and a resin foam forming raw material forming the base section 36, is injected into the mold for molding the base section 36, to cure a resin foam. Alternatively, a method may be adopted in which a member serving as the base member 36, is molded in advance, the member and the cord layer 40 molded on the inner mold 50 are placed in the mold, a raw material of the resin layer 39 is injected into the mold to then reaction-cure the injected raw material. Alternatively, a method may be adopted in which a member serving as the reinforcement section 38 is fabricated separately and the member is placed in the mold to then, form the base section 36.

Then, concrete description will be given of an example of manufacture of a run-flat tire support related to the embodiment.

### MANUFACTURE EXAMPLE 9 OF RUN-FLAT TIRE SUPPORT

### <1> Fabrication of Reinforcement Section Member

An inner mold (with dimensions of the outer diameter of 420 mm and the width of 110 mm) of a mold for molding a support was prepared. Eight protrusions extending in the width direction of the reinforcement section were formed at an equal spacing in the tire circumferential direction and a shape in side view of each protrusion was almost a trapezoid with dimensions of the width (the lower side) of 82.4 mm, the upper side of 83.2 mm and the height of 2.0 mm. A net with a product number KS5431 (manufactured by KANEBO, LTD.) formed with glass fibers (corresponding to the fiber layer) was wound double around the outer peripheral surface of the inner mold and then, an aramid cord with a linear density of 3300 dtex and a fiber diameter of 0.6 mm (manufactured by Toray Du Pont Ltd. with a trade name of KEVLAR and corresponding to the cord described above) is wound, a single turn, on the net spirally along the tire circumferential direction so that the number of ends is 10 cords/inch with a tension of 30 N. The both end portions were fixed in a cut-out formed on the inner mold.

60.5 g of MOCA (manufactured by Ihara Chemical Co., Ltd.) in a molten state at 120° C. was added into 500 g of Adiprene L-100 (manufactured by Uniroylal Co.), which is an isocyanate group-terminated prepolymer, at 80° C., the components were agitated and mixed, and thereafter, the mixture was vacuum-defoamed to produce a non-foam resin layer forming raw material.

The inner mold on which the cord layer was formed is assembled into a mold for molding a reinforcement section using a multi-split outer mold (with the inner diameter 426 mm and the width of 110 mm), which was heated at 100° C. Then, the non-foam resin layer forming raw material is injected into a cylindrical cavity which the reinforcement section mold has to cure the raw material at 100° C. for 1 hr and to fabricate the reinforcement section.

### <2> Fabrication of Base Section

The reinforcement section fabricated in the section <1> of Fabrication Example 9, together with in the inner mold, was mounted in the inner cylinder of the mold for molding a base section having the cylindrical cavity with dimensions of the outer diameter of 510 mm and the depth of 110 mm, which were heated at 100° C.

5000 g of Adiprene L-100 was heated at 80° C., into which 150 g of silicone surfactant SH-192 (manufactured by Toray Dow Corning Silicone Co., Ltd.) was added, and the mixture was agitated in a 20 L vessel in the air atmosphere using a biaxial agitator till a liquid volume increases twofold to thereby prepare a cell dispersion liquid in a meringue state. After a temperature of the cell dispersion liquid was adjusted at 50° C., 605 g of MOCA in a molten state at 120° C. was added to the cell dispersion liquid and mixed to uniformity to thereby prepare a resin foam forming raw material.

The obtained resin foam forming raw material was injected into the cylindrical cavity of the mold (with the outer diameter of 510 mm and the height of 110 mm) for molding the base section, which was heated and cured at 100° C. for 1 hr to thereby fabricate the base section having the reinforcement section. A density of a closed cell polyurethane resin foam from which the base section was made was 0.6 g/cm³ and a 5% offset stress was 2.0 MPa.

### <3> Fabrication of Non-Foam Resin Outer Layer

After the base section fabricated in the section <2> of Fabrication Example 9 was cured so as to enable the base section to be demolded from the mold, the mold portion forming the outer peripheral surface was removed and the outer mold capable of forming a cavity with the width of 2 mm on the outer periphery of the base section. The same non-foam resin forming raw material as in the section <1> of Fabrication Example 9 was injected into the cavity and cured at 100° C. for 1 hr. A support constituted of the reinforcement section and the base section and the non-foam resin layer, which had been obtained, was post-cured at 120° C. for 8 hr to thereby obtain a run-flat tire support. The inner diameter of the run-flat tire support after cooling was 417.5 mm. 10 evaluation samples were fabricated for evaluation of mountability to a rim and mount stability.

### MANUFACTURE EXAMPLE 10 OF RUN-FLAT TIRE SUPPORT

Run-flat tire supports were fabricated in a similar way to that in fabrication Example 9 with the exception that the inner mold without protrusion portions on the outer peripheral surface was used. That is, supports each without providing grooves on the inner peripheral surface were manufactured to prepare 10 evaluation samples in a similar way to that in Fabrication Example 9.

(Assembly of Run-Flat Tire)

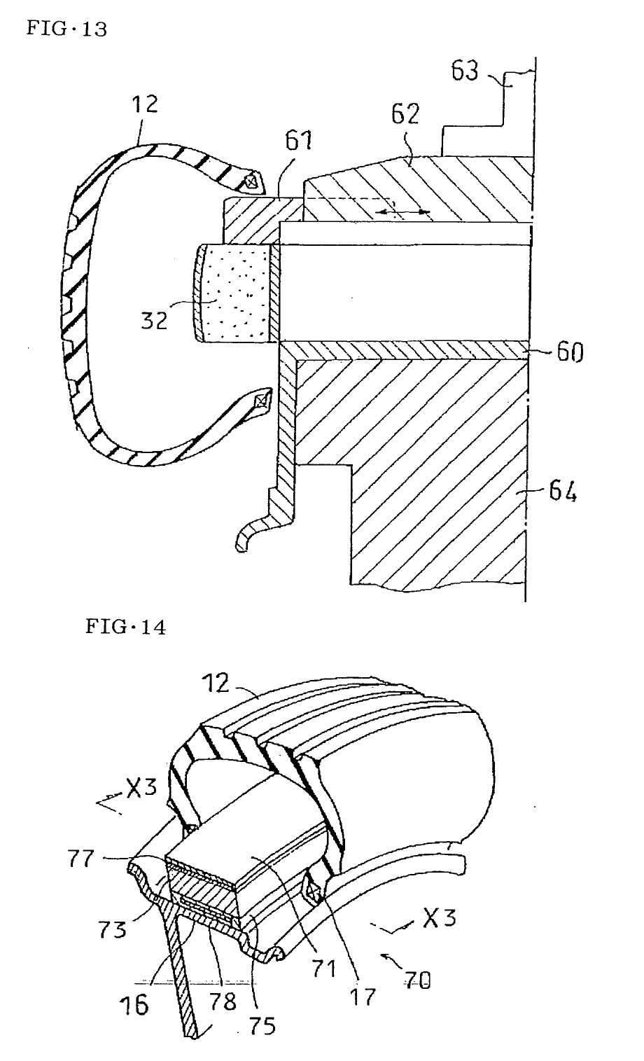

A split rim with the outer diameter of a support mounting portion of 418 mm was used and a run-flat tire was assembled with a mounting apparatus shown in FIG. 13. First of all, a run-flat tire support 32, was pushed into the inside of a tire 12 and a first rim member 60 on which the support was engagement-mounted was placed on a fixing table 64. Then, a mounting tool 62 having a protrusion 61 moved into the inside on the upper surface side of the tire 12 to press down the supporter 32, was pushed toward the fixing table 64 with an air cylinder 63. Thereby, the support 32, was mounted to the first rim member 60. Moreover, a second rim member (not shown) of the split rim was fixed with the first rim member 60 and a bolt, thereby completing assembly of the run-flat tire.

(Evaluation)

1) Easiness of Assembly

Evaluation was conducted on mountability while a run-flat tire was assembled following the above procedure. As a result, in 10 samples of Manufacture Example 9, the inner diameters of the supports when those were mounted to a rim were increased and the supports can be mounted with smoothness and easiness, but in samples of Manufacture Example 10, a stiffness of the inner peripheral surfaces was high and mounting to a rim was difficult as compared with the samples of Manufacture Example 9.

2) Mount Stability to Rim

The run-flat tire obtained in Manufacture Examples 9 and 10 were rotated at a rotation speed corresponding to a speed of 100 km/hr for 30 min. After the rotation test, it was visually evaluated whether or not the run-flat tire supports were displaced from the initial position and no displacement in the axial direction of the rim was recognized on any of the samples. That is, it was found that, in Manufacture Example 9, the supports were stably fixed even if the grooves were formed on the inner peripheral surfaces of the supports.

### THIRD EMBODIMENT

Then, description will be given of the third embodiment of the invention. A run-flat tire support of the embodiment has a construction in which not only was an outer side reinforcement fiber layer provided on the inner periphery side of a non-foam resin outer layer, but an inner side reinforcement fiber layer was also provided in the reinforcement section. Description of construction shared by the first embodiment such as a resin foam from which a base section is made and a non-foam resin from which a non-foam resin outer layer is made is omitted and description will be given mainly of different points therefrom.

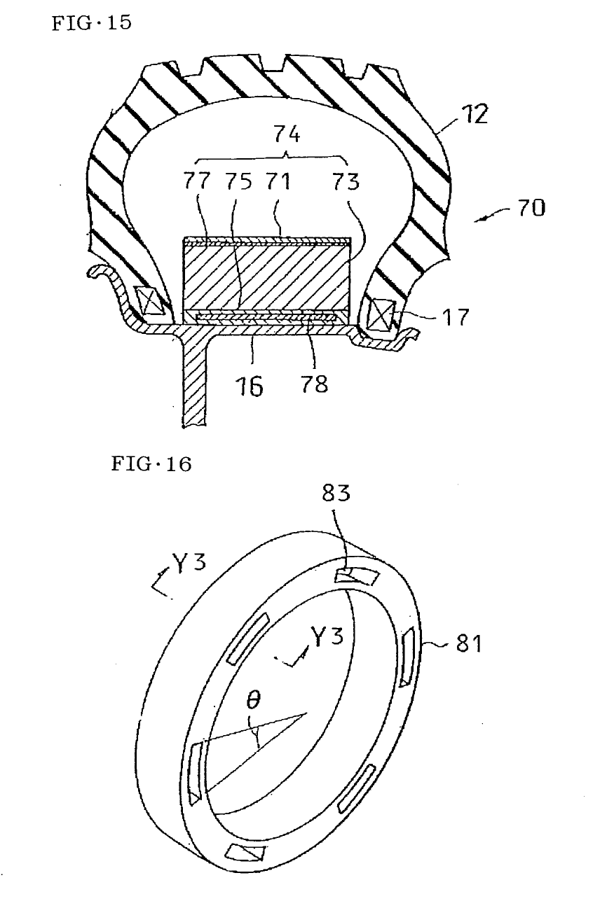

FIG. 14 is a perspective sectional view showing a structure of a run-flat tire related to the third embodiment. FIG. 15 is a sectional view taken on line X3 to X3 of FIG. 14.

A support 74 provided in a run-flat tire 70 of the embodiment includes: a base section 76 made from a resin foam; a non-foam resin outer layer 71 provided in the outer peripheral portion of the base section 73; and a reinforcement section 75 provided in the inner peripheral portion of the base section 73. In the embodiment, not only is an inner side reinforcement fiber layer 78 provided in the inside of the reinforcement section 75, but an outer side reinforcement fiber layer 77 is also provided inside the non-foam resin outer layer 71. With such a construction adopted, it is firmly prevented that the support receives a centrifugal force in ordinary driving not in a run-flat state, thereby, increasing a diameter thereof and rising up and moving.

Since the support 74 has such a structure, the base section 73 receives a collaborative action of the both reinforcement fiber layer 77 and 78 provided so as to hold the base section 73 from outer and inner sides in the circumferential direction to thereby sandwich the base section 73 therebetween even if a large centrifugal force is exerted continuously for a long time during driving, deformation of the base section 73 caused by a large centrifugal force during driving is firmly suppressed by the collaborative action, the support is firmly prevented from increasing a diameter thereof, rising up from the rim and moving due to the centrifugal force, and the support structure is firmly reinforced and excellent in durability.

The reinforcement section 75 is made from reinforcement fibers and a non-foam resin. The non-foam resin as a structural material of the reinforcement section is preferably a non-foam of a resin from which the base section 73 is made from the view point of an adhesion strength of the foam resin layer. The reinforcement fibers can be any of kinds of known reinforcement fibers without a limitation thereon, examples of which are as described above. The reinforcement fibers may be of either monofilament or something like a piano wire. The kinds of reinforcement fibers are preferably used after an adhesion treatment for improvement on adherence is applied thereon.

The following methods can be adopted as methods for providing the outer reinforcement fiber layer 77 on the inner side of the non-foam resin outer layer 71.

(1) A method in which in fabrication of the non-foam resin outer layer, the outer reinforcement fiber layer is disposed on the inner side of the non-foam resin outer layer and both layers are molded into a single piece.

(2) A method in which after the non-foam resin outer layer is fabricated, the outer reinforcement fiber layer is adhered to the inner side of the non-foam resin outer layer.

(3) A method in which reinforcement fibers are wound and adhered on the circumference of the base section molded in advance, if necessary, with an adhesive and thereafter, a material forming the non-foam resin outer layer is injected and molded.

The reinforcement section 75 can be formed by means of various methods; in one of which a reinforcement section member molded from reinforcement fibers and a non-foam resin in advance is placed in a mold, then a resin foam forming raw material is injected and a resin foam is cured, whereby not only is a base section formed but the base section is also simultaneously adhered to the reinforcement section member and in another of which a base section 73 molded in advance and reinforcement fibers are placed in a mold and then a non-foam resin forming raw material is injected to cause reaction-curing.

FIG. 16 is a perspective view showing another run-flat tire support. FIG. 17 shows a structure of a section taken on line Y3-Y3. The support 81 is constituted of an outer peripheral portion 89 and the inner peripheral portion 85 and recesses 83 and 84 are formed on the left and right sides for reduction in weight. A non-foam resin outer layer 82 is provided in the outermost layer of the outer peripheral portion 89 and an outer side reinforcement fiber layer 87 is provided on the inner periphery side. A reinforcement section 86 including an inner reinforcement fiber layer 88 is provided at the inner peripheral surface of the inner peripheral portion 85 which is the contact side with a rim. Formation positions, a shape and the number or the like of the recesses 83 and 84 are as described in the description of the first embodiment.

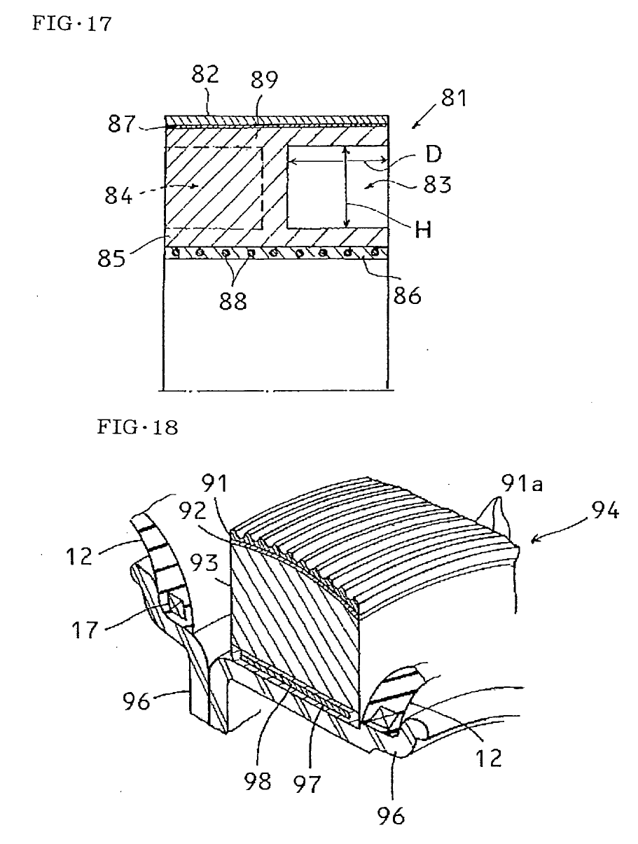

FIG. 18 is a view showing another run-flat tire support 94 mounted to a rim. Not only is a tire 12 mounted to a split rim 96, but the support 94 also has a non-foam resin outer layer 91 with many of grooves 91 a on a surface thereof. With such a construction adopted, since not only is a outer side reinforcement fiber layer 92 provided on the inner periphery side of the non-foam resin outer layer 91, but a reinforcement section 97 including an inner side reinforcement fiber layer 98 is also provided on the inner peripheral surface on the contact side with the rim 96, the support is similar in terms of strength to that in the embodiment described above, and besides, since many of grooves 91 a are formed on the surface of the non-foam resin outer layer 91, an advantage is realized that a weight of the support 94 is certainly reduced and as a result a weight of the whole of the run-flat tire is decreased. In addition, a construction may be adopted in which recesses each with a proper size, as shown in FIGS. 16 and 17, are formed on the side portions of the base section of the support.

Then, description will be given of an example of manufacture of a run-flat tire support related to the embodiment.

### MANUFACTURE EXAMPLE 11 OF RUN-FLAT TIRE SUPPORT

### <1> Fabrication of Reinforcement Section Member

A net formed with glass fibers (manufactured by KANEBO, LTD., with a product number of KS 5431) was wound on the outer peripheral surface of an inner cylinder of a mold for forming a reinforcement section which has a cylindrical cavity with dimensions of the inner diameter of 420 mm, the outer diameter of 426 mm and the depth of 110 mm, formed as an inner cylinder with the same outer diameter as a rim to which a run-flat tire is mounted.

60.5 g of MOCA (manufactured by Ihara Chemical Co., Ltd.) in a molten state at 120° C. was added into 500 g of Adiprene L-100 (manufactured by Uniroyal Chemical Co., Ltd.), which was an isocyanate group-terminated prepolymer at 80° C., both components was mixed by agitation and thereafter, vacuum defoamed to thereby prepare a non-foam resin forming raw material.

A reinforcement section mold in which the glass fiber net is placed is heated at 100° C., the non-foam resin forming raw material is injected into the cylindrical cavity to cure the injected raw material at 100° C. for 1 hr and to fabricate a reinforcement section member.

### <2> Fabrication of Base Section

The reinforcement member fabricated in the process <1> of Manufacture Example 11 was mounted on the inner cylinder of a mold for molding the base section having a cylindrical cavity with dimensions of an outer diameter of 504 mm, an inner diameter of 420 mm and a depth of 110 mm, followed by heating at 100° C.

5000 g of Adiprene L-100 was heated at 80° C., into which 150 g of silicone surfactant SH-192 (manufactured by Toray Dow Corning Silicone Co., Ltd.) was added, and the mixture was agitated in a 20 L vessel in the air atmosphere using a biaxial agitator till a liquid volume increases twofold to thereby prepare a cell dispersion liquid in a meringue state. After a temperature of the cell dispersion liquid was adjusted at 50° C., 605 g of MOCA in a molten state at 120° C. was added to the cell dispersion liquid and mixed to uniformity to thereby prepare a resin foam forming raw material.

The obtained resin foam forming raw material was injected into the cylindrical cavity of the mold for the base section to which the reinforcement section member was mounted and heat-cured at 100° C. for 1 hr to thereby prepare the base section in the shape shown in FIG. 16 having the reinforcement section. A density of the base section was 0.6 g/cm³ and a 5% offset stress was 2.0 MPa.

### <3> Fabrication of Non-Foam Resin Outer Layer

After a mold for an outer peripheral surface portion of a resin form layer having the reinforcement section fabricated in the section <2> of Manufacture Example 11 is disassembled, the same glass fiber net as the inner side reinforcement fiber layer used in a reinforcement member is wound, then a mold with dimensions of the outer diameter of 510 mm and the width (depth) of 110 mm is mounted to thereby form a cylindrical cavity on the outer peripheral surface of a base section having a reinforcement section. A polyurethane forming raw material into which adiprene L-100 and MOCA same as used in fabrication of the reinforcement section member of the section <1> of Manufacture Example 11 are mixed is injected into the cavity to cure the raw material at 100° C. for 8 hr, to form a non-foam resin outer layer having an outer side reinforcement fiber layer and-to thereby manufacture a run-flat tire support 9. The polyurethane resin from which the non-foam resin outer layer was made has a Shore A hardness of 90.

### MANUFACTURE EXAMPLE 12 OF RUN-FLAT TIRE SUPPORT

A run-flat tire support 10 was fabricated in a similar way to that in Manufacture Example 11 with the exception that a composition obtained by adding and mixing 128 g of MOCA into 500 g of Adiprene L-325 (manufactured by Uniroyal Chemical Co., Ltd.) as a raw material from which a non-foam resin outer layer was made was used. The polyurethane resin from which the non-foam resin outer layer had a Shore D hardness of 60.

### MANUFACTURE EXAMPLE 13 OF RUN-FLAT TIRE SUPPORT

A belt-like PET film with a thickness of 500 μm as a non-foam resin layer is corona discharge-treated on the inner surface thereof, thereafter a glass fiber net used in an inner side reinforcement fiber layer is adhered to the inner surface thereof using a polyurethane adhesive. The reinforcement section member fabricated in the section <1> of Manufacture Example 11 is mounted in the inner cylinder of a mold for molding a base section having an cylindrical cavity with dimensions of the outer diameter of 510 mm, the inner diameter of 420 mm and the depth of 110 mm, the belt-like PET film is adhered to the inner surface of a mold for molding the outer peripheral surface, the resin foam forming raw material in the section <2> of Manufacture Example 11 is injected into a remaining space of the cavity to fill the remaining space thereof with the raw material to cure the raw material therein at 100° C. for 8 hr, to manufacture a run-flat tire support 11.

### MANUFACTURE EXAMPLE 14 OF RUN-FLAT TIRE SUPPORT

A run-flat tire support 12 was fabricated in a similar way to that in Manufacture Example 11 with the exception that a belt-like Nylon 6,6 with a thickness of 25 μm was used as a non-foam resin outer layer.

### MANUFACTURE EXAMPLE 15 OF RUN-FLAT TIRE SUPPORT

A run-flat tire support 13 is manufactured in a similar way to that in Manufacture Example 11 with the exception that a chloroprene base adhesive is coated on the inner surface of a belt-like vulcanized SBR base rubber, as a non-foam resin outer layer, with a Shore A hardness of 90 and a thickness of 3 mm, to which a glass fiber net is adhered.

### MANUFACTURE EXAMPLE 16 OF RUN-FLAT TIRE SUPPORT

A run-flat tire support 14 was manufactured in a procedure in which the resin foam forming raw material of the section <2> of Manufacture Example 11 was injected into a cavity of a mold for molding a base section having a cylindrical cavity with dimensions of the outer diameter of 510 mm, the inner diameter of 420 mm and the depth of 110 mm so that the cavity was filled with the raw material, the raw material in the cavity was cured at 100° C. for 8 hr to thereby, manufacture a run-flat tire support 14 without either a reinforcement section or a non-foam resin outer layer.

### MANUFACTURE EXAMPLE 17 OF RUN-FLAT TIRE SUPPORT

A run-flat tire support 15 was manufactured in a procedure in which the reinforcement section member fabricated in the section <1> of Manufacture Example 11 was mounted in an inner cylinder of a mold for molding a base section having a cylindrical cavity with dimensions of the outer diameter of 510 mm, the inner diameter of 420 mm and the depth of 110 mm, the resin foam forming raw material fabricated in the section <2> of Manufacture Example 11 was injected into a remaining space of the cavity so that the remaining space thereof was filled with the raw material, the raw material in the remaining space thereof was cured at 100° C. for 8 hr to thereby, manufacture a run-flat tire support 15 without a non-foam resin outer layer.

### MANUFACTURE EXAMPLE 18 OF RUN-FLAT TIRE SUPPORT

A run-flat tire support 16 was manufactured in a procedure in which the reinforcement section member fabricated in the section <1> of Manufacture Example 11 was mounted in an inner cylinder of a mold for molding a base section having a cylindrical cavity with dimensions of the outer diameter of 510 mm, the inner diameter of 420 mm and the depth of 110 mm, the non-foam resin outer layer forming raw material fabricated in the section <3> of Manufacture Example 11 was injected into a remaining space of the cavity so that the remaining space thereof was filled with the raw material, the raw material in the remaining space thereof was cured at 100° C. for 8 hr to thereby, manufacture a run-flat tire support 16 constituted of a base section and a non-foam resin outer layer, both formed with a non-foam polyurethane resin. A density of the base section was 1.05 g/cm³.

(Evaluation)

Evaluation was conducted on a weight of a run-flat tire support and durability in a run-flat state. Durability in a run-flat state was tested in the following way.

<Manufacture of Run-Flat Tire>

Polypropylene glycol was coated on the inner surface of a tire (235/45ZR/17) as a lubricant and a support was inserted into the inside of the tire. A 17 inch 3P rim was mounted to the tire and the tire was filled with air to an air predetermined pressure, beads are set at predetermined position, and thereafter, the air pressure was reduced to zero. The run-flat tire was subjected to a driving test in a run-flat test with a drum tester in conditions of a load of 400 kgf and a driving speed of 80 km/h. In a result of evaluation, a run-flat tire support was evaluated “good” if it endured over a 3-h continuous driving (a driving distance of 240 km). Results are shown in Table 2.

TABLE 2

| | Manufacture | Manufacture | Manufacture | Manufacture | Manufacture | Manufacture | Manufacture | Manufacture |
|---|---|---|---|---|---|---|---|---|
| | Example 11 | Example 12 | Example 13 | Example 14 | Example 15 | Example 16 | Example 17 | Example 18 |
| Run-flat | Support 9 | Support 10 | Support 11 | Support 12 | Support 13 | Support 14 | Support 15 | Support 16 |
| tire | | | | | | | | |
| supports | | | | | | | | |
| in use | | | | | | | | |
| Support | 3.0 kg | 3.0 kg | 2.7 kg | 2.7 kg | 3.1 kg | 2.4 kg | 2.7 kg | 4.2 kg |
| weights | | | | | | | | |
| Durability | Good | Good | Good | Good | Good | Stoppage | Stoppage | Good |
| | | | | | | after 0.5 h | after 0.8 h | |
| | | | | | | driving due | driving due | |
| | | | | | | to surface | to surface | |
| | | | | | | wear | wear | |

It is understood from the results that a run-flat tire support of the invention is light in weight, endurable to a wear caused by a slide between the support and the inner surface of the tire and has characteristics required as a run-flat tire support.

### FOURTH EMBODIMENT

Then, description will be given of the fourth embodiment of the invention. In a run-flat tire support of the embodiment, a base section is made from a closed cell resin foam and a reinforcement section includes: a non-foam resin; a composite reinforcement fiber layer constituted of a fiber layer on the rim side formed in the non-foam resin and a cord layer obtained by winding a cord in the circumferential direction of the rim on the outer side of the fiber layer. Description of construction shared by the first embodiment such as a resin foam from which a base section is made and a non-foam resin from which a non-foam resin outer layer is made is omitted and description will be given mainly of different points therefrom.

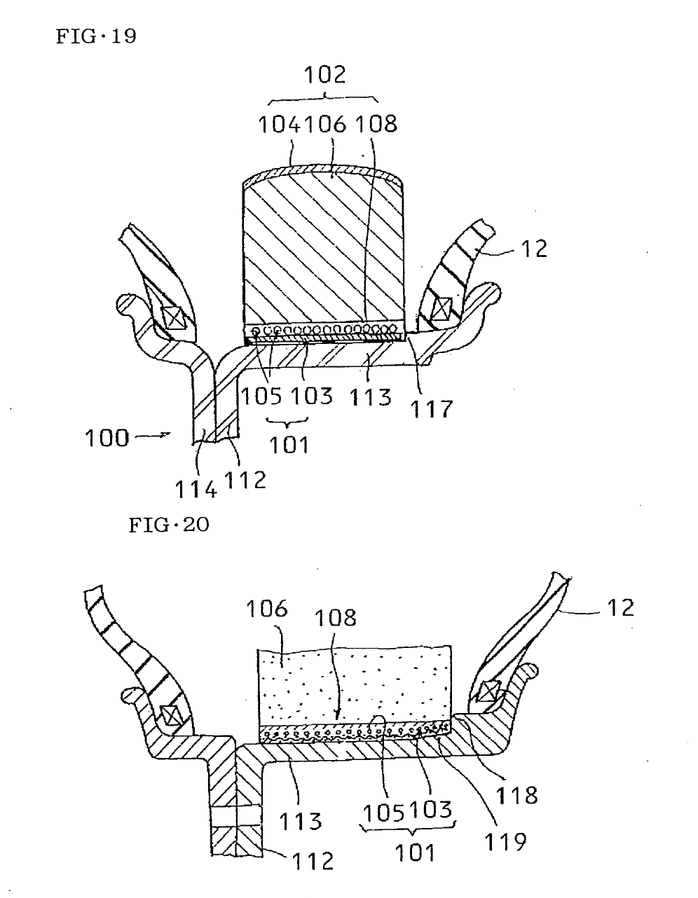

FIG. 19 is a sectional view showing an example of run-flat tire having a run-flat tire support related to the fourth embodiment fixedly mounted to a rim. The rim is a split rim constituted of at least two members including: a first rim member 112 having a flat portion 113 on which a run-flat tire support 102 is fixedly mounted; and a second rim member 114 with a flange on which a tire bead portion is simply rested.

A run-flat tire 100 is constituted of a tire 12 fixedly mounted to a rim; and a support 102 . The support 102 includes: a base section 106 made from a closed cell resin foam; a non-foam resin outer layer 104 provided in the outer peripheral portion of the base section 106 facing the inner surface of the tire; and a reinforcement section 108 provided in the inner peripheral portion of the base section 106 facing a flat portion 113 of a first rim member 112. The non-foam resin outer layer 104 may be formed so as to extend to the side portions of the base section 106 without covering all of the side portions. The reinforcement section 108 is constituted of: a non-foam resin; and a composite reinforcement layer 101 including a fiber layer 103 on the inner side (the rim side), which is formed in the non-foam resin, for preventing the support from increasing a diameter thereof under an influence of a centrifugal force during ordinary driving not in a run-flat state, rising up from the rim and moving, and a cord layer 105 obtained by winding a cord on the outer side of the fiber layer 103 in the circumferential direction of the rim.

In the embodiment, a stopper 117 is provided between the flat portion 113 of the first rim member 112 on which the support 102 is mounted, and a flange portion receiving the bead portion of the tire 12 , and the stopper 117 has an action to determine a position of the support 102 when the support 102 is engagement-mounted thereon.

In FIG. 20, there is shown an example of the support mounting portion of the rim having a portion different in diameter from the other. The portion 119 that has a diameter tapered toward the center of the flat portion 113 of the first rim member of a split rim was formed on the rim end portion side thereof and a stopper 118 for positioning the support is further formed on the rim end portion side thereof.

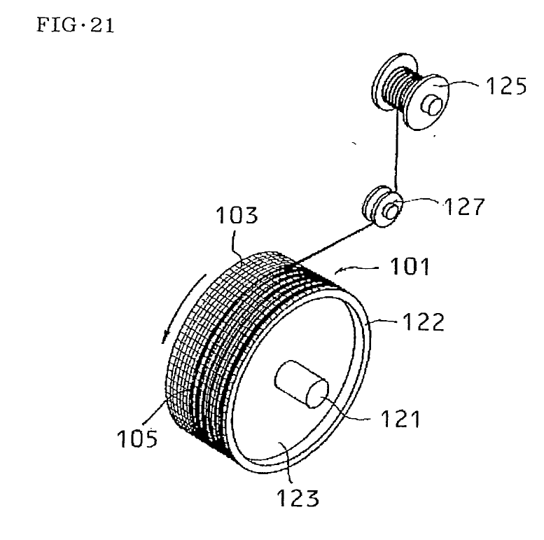

FIG. 21 is a perspective view showing an example of way that a composite reinforcement fiber layer 101 is formed. The inner mold 122 is a mold forming a rim mounting surface (the inner peripheral surface) of a mold for a run-flat tire support. The inner mold 122 is mounted rotatably by a rotary shaft to a composite reinforcement fiber layer forming apparatus constituted of the rotary shaft 121 and a mold holding member 123. The fiber layer 103 is wound, at least a single turn, manually or with a necessary fiber layer supply apparatus and properly fixed using an adhesive or a holding member. A cord is supplied from a master roll bobbin 125 onto the fiber layer 103 through a tension loading apparatus 127 while a tension is adjusted to take a predetermined value to thereby wind the cord on the fiber layer 103 at a predetermined spacing to form the composite reinforcement fiber layer 101.

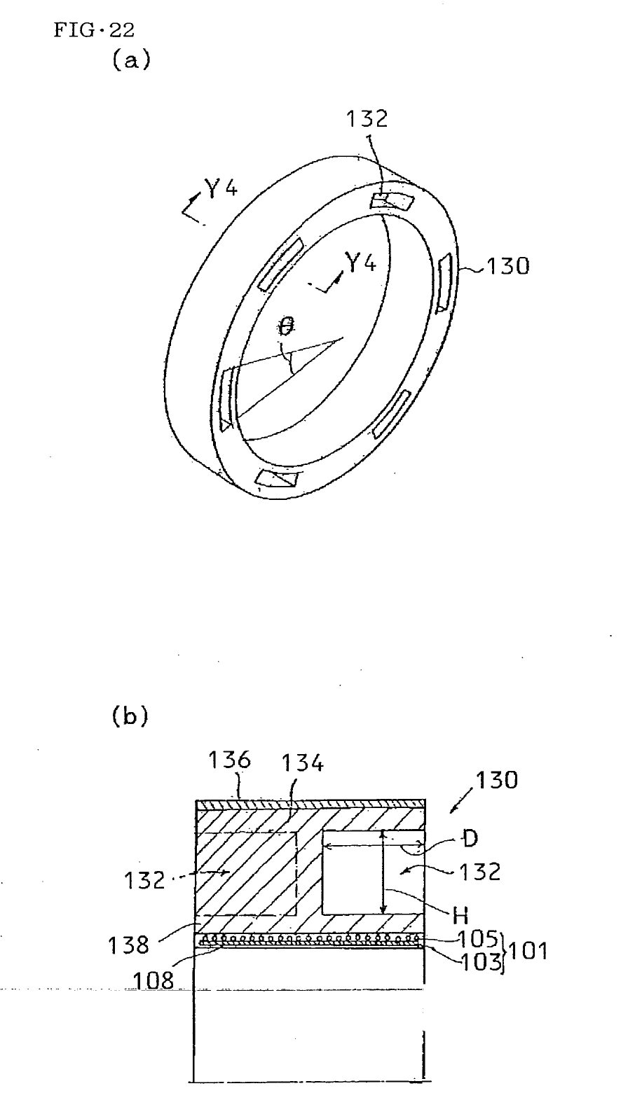

FIG. 22 shows another example of run-flat tire support, wherein FIG. 22(a) is a perspective view and FIG. 22(b) is a section taken on line Y4-Y4 of FIG. 22(a). Recesses 132 each in the sectional shape of a rectangle in diametral direction are formed on the sides of the support 130. The support 130 includes: a base section having the outer peripheral portion 134, the inner peripheral portion 138 and recesses 132, wherein the recesses 132 are alternately formed on the left and right side portions in the circumferential direction. A non-foam resin outer layer 136 is provided in the outermost layer of the outer peripheral portion 134, and a reinforcement section 108 including a composite reinforcement fiber layer 101 constituted of a fiber layer 103 and a cord layer 105 in a similar way to that shown in FIG. 19 is provided on the inner peripheral surface side of the inner peripheral portion 138 which is the contact side with the rim. Formation positions, a shape and the number or the like of the recesses 132 are as in the description of the first embodiment.

The fiber layer 103 is preferably constructed with a woven cloth or a net. Any of known fiber materials can be used without a limitation thereon as a material from which the fiber layer 103 is made. Examples thereof include: a rayon fiber; polyamide fibers such as a Nylon-6,6 fiber; polyester fibers such as a polyethylene terephthalate fiber; an aramid fiber, a glass fiber or the like. The fiber layer 103 may be formed either by cutting a base cloth into stripes with a necessary width and a necessary length and winding the stripes thereon, or by winding a tape narrower than the width of the support thereon. The fiber layer 103 is preferably wound without applying a large tension as done when being wound simply by a hand. The fiber materials are preferably used after being adhesion-treated for increasing adherence to a resin.

Any of known cords can be used without a limitation thereon as a cord wound on the outer side of the fiber layer 103 and the cords as described above can be used as examples. Of the fiber materials, preferable used are a steel cord and an aramid cord. The cord is wound on the fiber layer 103 under a predetermined tension. A tension when the cord is wound is preferably in the range of from 5 to 50 N (about 0.5 to about 5 kgf). If a tension is excessively low, a uniformity in cord arrangement is, in a case, degraded and a fixing force in engagement with a rim is, sometime, not sufficiently exerted, while if a tension is excessively high, a case arises where mounting to the rim cannot be realized due to fluctuations in inner diameter of the support.

A non-foam resin, from which a reinforcement section is made preferably has a 100% modulus in the range of from 2 to 20 MPa for the reason. The non-foam resin is preferably a non-foam of a resin from which the base section 106 is made from the viewpoint of an adhesion strength. As the non-foam resin, preferably used are an elastic epoxy resin and a curable polyurethane, and more preferably used is a polyurethane resin from the viewpoint of excellency in durability in dynamic deformation and in mechanical strength. The reinforcement section 108 preferably contains no cell.

The reinforcement section 108 can be fabricated by means of various methods; in one of which a reinforcement member molded with an outer mold for molding a reinforcement section from a composite reinforcement fiber layer formed in the inner mold in advance and a non-foam resin is not demolded from the inner mold are placed in a mold and a resin foam forming raw material from which the base section 106 is made is injected into the mold to cure a resin foam, and not only to form the base section 106 but also to simultaneously adhere the base section 106 to the reinforcement section member, in a second one of which the base section 106 molded in advance and the composite reinforcement fiber layer 101 formed on the inner mold are placed in a mold and a non-foam resin forming raw material is injected into the mold to thereby reaction-cure the raw material, and in a third one of which a reinforcement member is separately molded and is placed in a support mold to thereby form a base section 106.

Then, concrete description will be given of an example of manufacture of a run-flat tire support related to the embodiment.

### MANUFACTURE EXAMPLE 19 OF RUN-FLAT TIRE SUPPORT

### <1> Fabrication of Reinforcement Section Member

A net with a product number KS5431 (manufactured by KANEBO, LTD.) formed with glass fibers was wound double around the outer peripheral surface of the inner mold using the apparatus shown in FIG. 21 as an example. Then, an aramid cord with a linear density of 3300 dtex and a fiber diameter of 0.6 mmk (manufactured by Toray Du Pont Ltd. with a trade name of KEVLAR) so that the cord is wound, in one layer, on the net spirally so that the number of ends is 10 cords/inch with a tension of 30 N and the both end portions were fixed in a cut-out formed on the inner mold.

60.5 g of MOCA (manufactured by Ihara Chemical Co., Ltd.) in a molten state at 120° C. was added into 500 g of Adiprene L-100 (manufactured by Uniroyal Chemical Co., Ltd.), which was an isocyanate group-terminated prepolymer at 80° C., both components was mixed by agitation and thereafter, vacuum defoamed to thereby prepare a non-foam resin forming raw material.

An inner mold with which a composite reinforcement fiber layer is formed is placed in a mold constituting a reinforcement section mold using a multi-split outer mold (with dimensions of 426 mm and the depth of 110 mm) forming an outer circumference, which is heated at 100° C., and the non-foam resin forming raw material is injected into a cylindrical cavity to cure the raw material at 100° C. for 1 hr and to thereby fabricate a reinforcement section member. The reinforcement section member is transferred to a base section forming step without disassembling the inner mold therefrom.

### <2> Fabrication of Base Section

The reinforcement member fabricated in the section <1> of Manufacture Example 19, together with the inner mold, is mounted in an inner cylinder of a mold for a base section having a cylindrical cavity with dimensions of the outer diameter of 510 mm and the depth of 110 mm, which are heated at 100° C.

5000 g of Adiprene L-100 was heated at 80° C., into which 150 g of silicone surfactant SH-192 (manufactured by Toray Dow Corning Silicone Co., Ltd.) was added, and the mixture was agitated in a 20 L vessel in the air atmosphere using a biaxial agitator till a liquid volume increases twofold to thereby prepare a cell dispersion liquid in a meringue state. After a temperature of the cell dispersion liquid was adjusted at 50° C., 605 g of MOCA in a molten state at 120° C. was added to the cell dispersion liquid and mixed to uniformity to thereby prepare a resin foam forming raw material.

Obtained resin foam forming raw material was injected into a cylindrical cavity of a mold for a base section (with dimensions of the outer diameter of 510 mm and the height of 110 mm) to which a reinforcement section member was mounted to heat-cure the raw material at 100° C. for 1 hr to thereby fabricate a base section in the shape shown in FIG. 22 having a reinforcement section. A density of a closed cell polyurethane foam from which the base section was made was 0.6 g/cm³ and a 5% offset stress was 2.0 MPa.

After the base section was demoldably cured, a mold portion forming the outer peripheral surface was disassembled, an outer mold capable of forming a cavity with the width of 2 mm was placed on the outer circumference of the base section, a non-foam resin forming raw material forming a non-foam polyurethane resin same as used in fabrication of a reinforcement section was injected into the cavity to cure the raw material at 100° C. for 1 hr. A support constituted of the reinforcement section, the base section and the non-foam resin outer layer, thus obtained, was post-cured at 120° C. for 8 hr to thereby obtain a run-flat tire support. The inner diameter of the run-flat tire after cooling was 417.5 mm. 10 samples of Manufacture Example 19 were prepared in a similar way in order to evaluate mountability and a mount stability to a rim. The Manufacture Example 19 samples were all sufficient in filling the inner peripheral surface with a polyurethane resin, which is a. non-foam resin.

### MANUFACTURE EXAMPLE 20 OF RUN-FLAT TIRE SUPPORT

A run-flat tire support was manufactured in a similar way to that in Manufacture Example 19 with the exception that a cord layer is provided directly without using a fiber layer. In this case, since, if the same inner mold as in Manufacture Example 19 is used, demolding cannot be realized because of effects of cure-shrinkage of a polyurethane, which is non-foam resin, and a cord layer, the inner mold was split into 3 pieces with which a run-flat tire support was manufactured. 10 evaluation samples were prepared in a similar way to that in Manufacture Example 19. In the Manufacture Example 20 samples, the inner peripheral surface were insufficiently filled with a polyurethane resin, which is a non-foam resin, resulting in more of voids.

(Assembly Example of Run-Flat Tire)

A support mounting portion was constituted of a split rim with the outer diameter of 418 mm and a mounting apparatus with the same construction as in the apparatus shown in FIG. 13 was used to assemble a run-flat tire. First of all, the run-flat tire support was pushed into the inside of the tire 12, a first rim member of the split rim to which the support is engagement-mounted was placed on a fixing table 64 and the tire 12 and the support were aligned with the rim. A mounting tool 62 having a protrusion 61 pushing the support by moving into the inside of the upper surface side of the tire 12 is pushed toward the fixing table 64 with an air cylinder 63 to thereby the supporter was mounted on the rim. Besides, a second rim member of the split mold was fixed with the first rim member and a bolt to thereby complete assembly of a run-flat tire.

(Evaluation)

1) Easiness of Assembly

10 samples of Manufacture Example 19 were able to be mounted without any trouble, 4 samples of Manufacture Example 20, which corresponds to 40% of the total samples in number, was slightly larger in cure-shrinkage than the others, the inner diameters were less than 418 mm and stiffness of the inner peripheral surfaces was too high, thereby disabling the samples to be mounted to the rim.

2) Mount Stability to Rim

The run-flat tires obtained in Manufacture Examples 19 and 20 were rotated at a rotation speed corresponding to a speed 100 km per hr for 30 min. After rotation, it was visually evaluated whether or not a run-flat tire support was displaced from the initial position, with the result that, it was found, no displacement in a direction of the shaft of the rim is recognized on the samples from Manufacture Example 19. Therefore the samples were found to be fixed with stability. Contrast thereto, the samples from manufacture Example 20 were able to be mounted to the rim, but 2 samples suffer displacement and problematical mount stability though 4 samples were not problematical.

### MANUFACTURE EXAMPLE 21 OF RUN-FLAT TIRE SUPPORT

As shown in FIG. 20, a support having a portion different in inner diameter from the other and mounting to a rim with a portion different in diameter from the other was manufactured. A taper was formed on the inner mold so that a diameter increases toward one end in length of 30 mm from the end at an angle of 5 degrees and the support was manufactured in a similar way to that in Manufacture Example 19. After manufacture, fluctuations in arrangement of an aramid cord was visually evaluated with the result that no disturbance in arrangement of a cord layer was observed on samples of Manufacture Example 21 in which the cord is wound on a net as an underlying layer.

### MANUFACTURE EXAMPLE 22 OF RUN-FLAT TIRE SUPPORT

A support was manufactured in a similar way to that in Manufacture Example 19 without winding a net on an inner layer, with the results that a cord is displaced to the smaller diameter side in a taper portion and a disorder in arrangement of the cord was observed in the taper portion.

### FIFTH EMBODIMENT

Then, description will be given of the fifth embodiment of the invention. Description of part of the construction shared by that of the first embodiment is omitted.

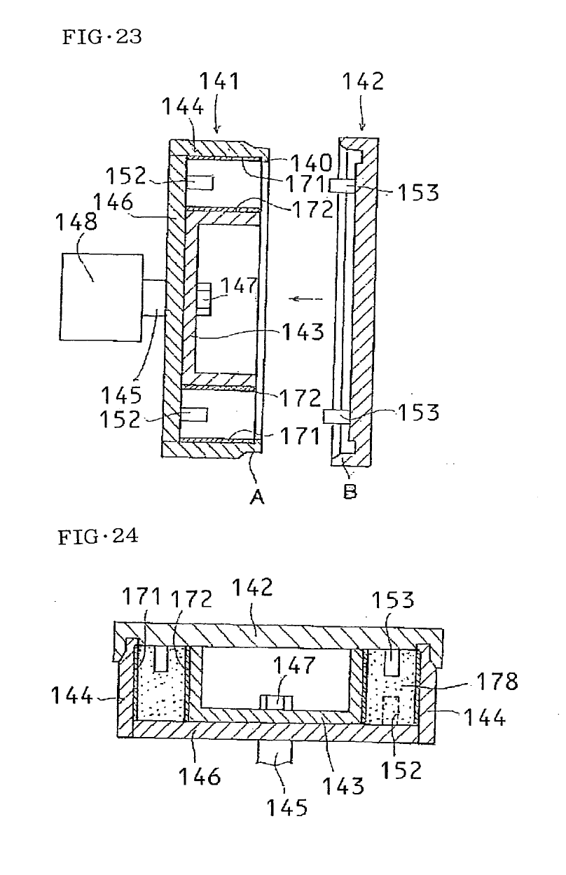

FIGS. 23 and 24 are sectional views showing a step of manufacturing a run-flat tire support using a mold preferable to execution of a manufacturing method for a run-flat tire support of the invention.

A mold is constituted of: a motor 148; a first mold 141 capable of mounting to a rotary shaft 145 driven by the motor 148; and a second mold 142 forming a molding cavity by engagement-mounted to the first mold 141. The first mold 141 is constituted of a first lateral mold 146 forming one side surface of the support; an outer mold 144 forming the outer peripheral surface of the support; and an inner mold 143 forming the inner peripheral surface of the support. A flange 140 is provided to the outer mold 144 for forming a non-foam resin outer layer 171 . The inner mold 143 is mounted to the first lateral mold 146 and the rotary shaft 145 in a freely dismountable manner with a bolt 147. The outer mold 144 and the inner mold 143 are preferably split into plural pieces and more preferably two to four pieces in the circumferential direction because of easy demolding of the support after molding.

Plural protrusions 152 and 153 for forming recesses on the sides of a base section made from with a closed cell resin foam are provided to the first lateral mold 146 and the second lateral mold 142, respectively.

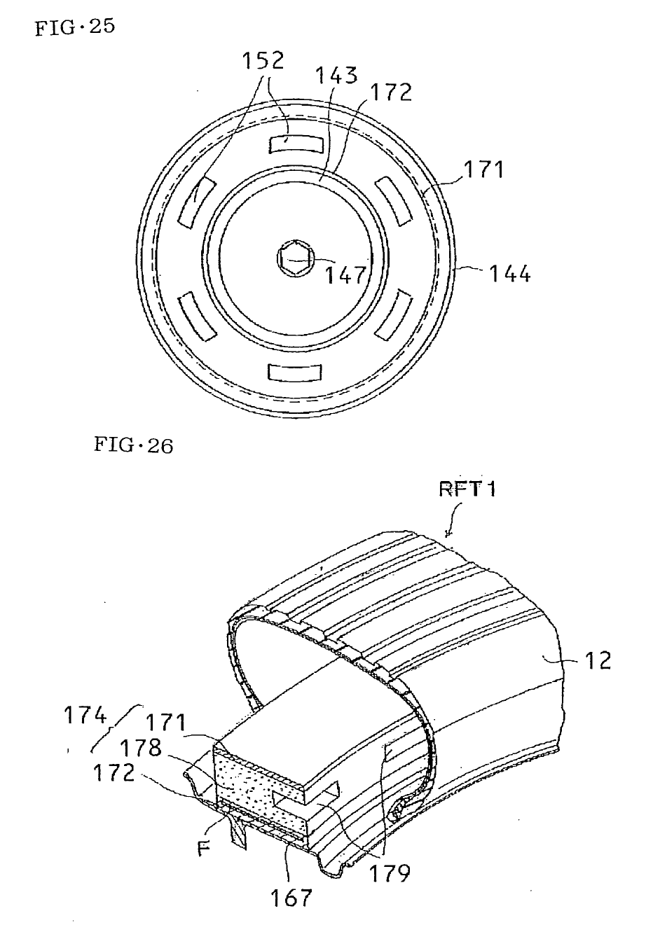

Description will be given of a process for manufacturing a run-flat tire support using a mold shown in FIGS. 23 to 25 as an example. A reinforcement fiber layer F is wound on the inner mold 143, which is fixed to the first lateral mold 146 with the bolt 147. The outer mold 144 is fixed to the periphery of the first lateral mold 146 to thereby, as shown in FIG. 23, form a cavity for forming a base section.

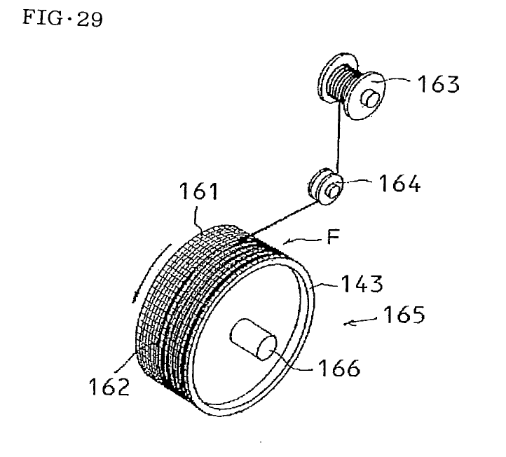

In FIG. 29, there is shown a step of forming the reinforcement fiber layer F on the inner mold 143. The inner mold 143 is mounted to a rotary shaft 166 driven by a motor (not shown). A net 161 as a first layer is wound at least single turn manually or using a necessary net supply apparatus and the wound net 161 is properly fixed with an adhesive or a holding member. A cord 162 is supplied onto the net layer 161 from a master roll bobbins 163 so as to be given a predetermined tension through a tension loading apparatus 164 and wound on the net layer 161 at a predetermined spacing to thereby form the reinforcement fiber layer F.

A non-foam resin raw material forming a non-foam resin outer layer 171 is supplied on the inner surface of the outer mold 144 of the first mold 141 shown in FIG. 23 to a predetermined thickness. In a case where fluidity of the non-foam resin raw material is high, the first mold 141 may be rotated at a high speed with the motor 148 to mold by centrifugal molding, while in cases where the non-foam resin raw material is high in reactivity and a fluidity is reduced immediately after coating and where the non-foam resin raw material is high in thixotropy and therefore, a fluidity is low though curing is slow, the first mold 141 can be rotated at a low speed to form a film. In a case where the non-foam resin raw material is high in fluidity and therefore, centrifugal molding is applied, a reaction is advanced by heating or the like and continued till the fluidity is lost.

The reinforcement fiber layer F formed on the outer peripheral surface of the inner mold 143 is coated or impregnated with a non-foam resin raw material from which the reinforcement section is made. Since the non-foam resin raw material from which the reinforcement section is made is necessary to permeate the reinforcement layer F, the raw material requires a fluidity. In a case where the reinforcement fiber layer F is coated or impregnated with a non-foam resin raw material, the non-foam resin raw material is supplied in a state as shown in FIG. 23 and may be coated with a blade or a coater, or alternatively, a molding cavity is, as shown in FIG. 24, positioned to be horizontal, the outer mold for forming the reinforcement section is placed around the reinforcement layer F, the non-foam resin raw material may be poured into between the inner mold 143 on which the reinforcement fiber layer F is provided and the outer mold for forming the reinforcement section. In this case, the outer mold for forming a reinforcement section is disassembled and removed in a state where a curing reaction of the non-foam resin raw material advances and the raw material has lost fluidity.

The first mold 141 is rotated in a state where the non-foam resin raw material forming a non-foam resin outer layer and the non-foam resin raw material from which the reinforcement section is made has lost fluidity, the molding cavity is positioned to be horizontal, a raw material from which the base section is made is poured into the base section forming cavity and then, the second mold 142 is engaged with the first mold 141 by fitting A into B. In this state, the base section raw material is reacted and cured to thereby form a run-flat tire support.

A base section forming raw material is injected with a proper method such as injection molding or casting. In a case where a base section forming raw material has natural fluidity like a polyurethane foam raw material, it is allowed that a mold is positioned to be horizontal as shown in FIG. 24 and casting is adopted, while in a case where injection molding is adopted, a mold is, in a state as shown in FIG. 23, filled with a base section forming raw material without rotation of the mold as an additional operation.

In a manufacturing method for a run-flat tire support of the invention, a non-foam resin outer layer, a base section and a reinforcement section forming non-foam resin are all preferably formed with a reaction-curable polyurethane resin and with such a construction adopted, a support molded by means of the manufacturing method is obtained in a state where adhesion strength between layers is very good since a polyurethane resin foam forming raw material forming a base section is supplied in a state where the non-foam resin and a reinforce section forming non-foam resin are not completely cured though both lack of fluidity and cured into a single piece.

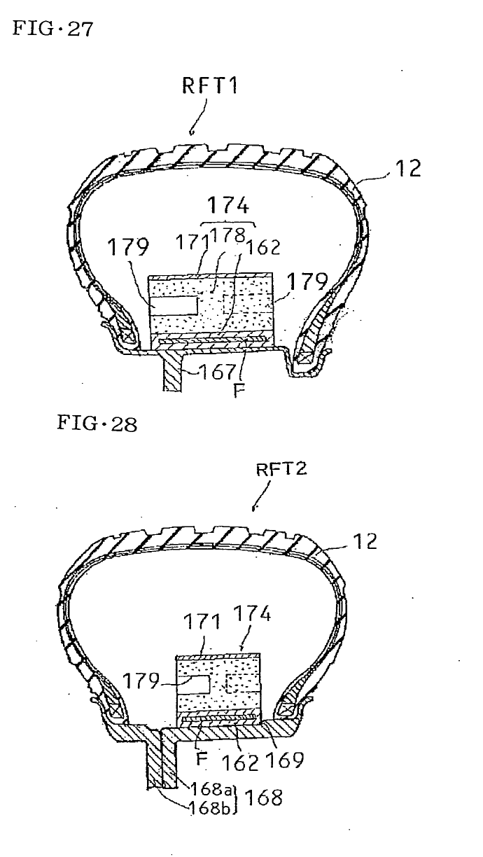

Examples of run-flat tire support are shown in FIGS. 26 and 27. The run-flat tire support 174 has the same structure as the support 21 shown in the embodiment described above. The support 174 is constituted of a non-foam resin outer layer 171 provided in the outer peripheral portion facing the inner surface of the tire; a reinforcement section 172 engaged on a support mounting portion of a rim; and a base section 178 made from a closed cell resin foam. The outer periphery of the support 174 is not necessarily required to be flat. The reinforcement fiber layer F from which the reinforcement section 172 is made has an action to prevent the support from increasing a diameter, rising up from a rim and moving under an influence of a centrifugal force during ordinary driving not in a run-flat state.

In FIGS. 26 and 27, there is shown an example of construction using a single piece rim for a run-flat tire of the invention. In a run-flat tire RFT1, a support 174 is mounted in the central portion of a rim 167 and the tire 12 is mounted on the outer sides thereof. Plural recesses 179 each in the sectional shape of a rectangle are formed on the sides of the support 174.

In FIG. 28, there is shown a run-flat tire RFT2 using a split rim as an example. In the example, the split rim 168 is constituted of: a first rim member 168 a having a flat portion on which the support is mounted; and a second rim member 168b, and in the first rim member 168a, a stopper 169 is provided between the flat portion on which the run-flat tire support 174 is mounted and a flange portion on which the bead portion of the tire 12 is rested and the stopper exerts an action to determine a position of the support 174 in a case where the support 174 is engagement-mounted to the first rim member 168a.

In a manufacturing method for a run-flat tire support of the embodiment, the reinforcement fiber layer, which is a reinforcement forming material, is formed with a cord, a woven cloth or a net wound in the circumferential direction. Preferable among them is a cord layer obtained by winding a cord in the circumferential direction and also preferable is a construction in which a woven cloth or a net is wound on the inner layer (rim side) or the outer layer of the cord layer. Any of known structural materials such as a cord, a woven cloth and a net can be used without a limitation thereon and the materials described above are exemplified. A cord is wound on a fiber layer under a predetermined tension and a tension when in winding the cord is preferably in the range of from 5 to 50 N (about 0.5 to about 5 kgf). Fiber material from which a reinforcement fiber layer is made is preferably used after an adhesion treatment applied thereon for improving adherence to a non-foam resin.

A non-foam resin, which is a reinforcement section forming material, preferably has a 100% extension modulus in the range of from 2 to 20 MPa. As non-foam resin, preferably used are elastic epoxy resin and curable polyurethane resin and a reaction-curable polyurethane is preferably used in that the resin is excellent in durability to dynamic deformation and mechanical strength.

A base section constituting a run-flat tire support manufactured according to the invention is preferably a closed cell resin foam with a density at least in the range of 0.3 to 0.9 g/cm³ because of reduction in weight as a whole of the tire and more preferably a closed cell polyurethane resin foam having an average cell diameter in the range of from 20 to 200 μm. Such a support is especially light in weight and excellent in mechanical strength and elasticity.

A non-foam resin outer layer forming resin provided on the outer peripheral surface of a base section may be either a resin different from a base section forming resin or the same resin as a base section forming resin, but preferably used is the same polyurethane resin as the base section. A thickness of a non-foam resin outer layer is not specifically limited and any value may be adopted as far as a driving distance necessary in a run-flat state is secured, but a thickness thereof is preferably in the range of 0.01 to 3 mm. If a thickness of a non-foam resin outer layer is excessively thin, a slight wear cause a slide between the base section and the inner surface of the tire, while a thickness thereof is excessively thick, it negates a request for reduction in weight of the support.

Then, concrete description will be given of a manufacture example of a run-flat tire support using a manufacturing method related to the embodiment.

### MANUFACTURE EXAMPLE 23 OF RUN-FLAT TIRE SUPPORT

### <1> Fabrication of Fiber Reinforcement Layer

An aramid cord with a linear density of 3300 dtex and a fiber diameter of 0.6 mm (manufactured by Toray Du Pont Co., Ltd, with a trade name of KELVAR) was wound, spirally and in a single turn, on the outer peripheral surface of the inner mold with dimensions of the outer diameter of 420 mm and the width of 110 mm) of a support mold so that the number of ends is 8 cords/inch using the apparatus shown in FIGS. 23 to 25 with a tension of 30 N and both ends are fixed in a cut-out formed on the inner mold to thereby form a composite reinforcement fiber layer. The inner mold was fixedly mounted to the first lateral mold with a bolt.

### <2> Fabrication of Non-Foam Resin Outer Layer

60.5 g of MOCA (manufactured by Ihara Chemical Co., Ltd.) in a molten state at 120° C. was added 500 g of Adiprene L-100 (manufactured by Uniroyal Co., Ltd.), which was an isocyanate group-terminated prepolymer heated at 80° C., the mixture was agitated and mixed, thereafter vacuum defoamed to obtain a polyurethane master liquid, which is a non-foam resin forming raw material.

In the state shown in FIG. 23, the non-foam resin raw material was cast on the inner surface of the outer mold while the first mold was heated at 100° C. and rotated at a speed of 200 rpm to obtain a film with a thickness of 2 mm. The film was heated at 100° C. for 10 min and the polyurethane master liquid was gelled and lost a fluidity.

<3>

The same polyurethane master liquid as used for forming the non-foam resin outer layer on the reinforcement fiber layer formed on the inner mold was coated while the first mold was slowly rotated. The polyurethane master liquid was gelled and lost fluidity by heating at 100° C. for 10 min. In this state, the first mold was rotated to take a horizontal position.

<4> Fabrication of Base Section

5000 g of Adiprene L-100 was heated at 80° C., into which 150 g of silicone surfactant SH-192 (manufactured by Toray Dow Corning Silicone Co., Ltd.) was added, and the mixture was agitated in a 20 L vessel in the air atmosphere using a biaxial agitator till a liquid volume increases twofold to thereby prepare a cell dispersion liquid in a meringue state. After a temperature of the cell dispersion liquid was adjusted at 50° C., 605 g of MOCA in a molten state at 120° C. was added to the cell dispersion liquid and mixed to uniformity to thereby prepare a resin foam forming raw material.

An obtained closed cell resin foam forming raw material was injected into a cylindrical cavity forming the base section of the first mold and the second mold was engagement-mounted and the raw material was heat-cured at 100° C. for 1 hr to thereby form a run-flat tire support having the non-foam resin outer layer, the base section and the reinforcement section, all formed with a reaction-cured polyurethane resin in a single piece.

A density of a closed cell polyurethane resin foam from which the base section was made was 0.6 g/cm³ and a 5% offset stress was 2.0 MPa.

The support constituted of the reinforcement section, the base section and the non-foam resin layer, obtained as described above, was post cured at 120° C. for 8 hr to obtain a run-flat tire support. The inner diameter of the run-flat tire support after cooling was 416 mm.

1. A run-flat tire support mounted to a rim comprising: a base section made from a resin foam with a density in the range of from 0.3 to 0.9 g/cm³; a reinforcement section provided on the inner peripheral portion of the base section; and a non-foam resin outer layer covering a contact surface of the base section with the inner surface of the tire during driving in a run-flat state.

2. The run-flat tire support according to claim 1, wherein the resin foam is a closed cell polyurethane resin foam with an average cell diameter in the range of from 20 to 200 μm.

3. The run-flat tire support according to claim 1, wherein the base section has plural recesses on the side surfaces thereof.

4. The run-flat tire support according to claim 1, wherein the reinforcement section is constituted of at least reinforcement fibers and a non-foam resin.

5. A run-flat tire to which a run-flat tire support according to claim 1 is mounted.

6. The run-flat tire according to claim 5, wherein a lubricant with a low swellability is applied to at least one of the inner surface of a tire and the outer peripheral surface of the run-flat tire support, the lubricant being low in swellability both on a rubber material from which the inner surface of a tire is made and on a material from which the outer peripheral surface of the run-flat tire support is made.

7. The run-flat tire support according to claim 1, wherein
the base section is made from a closed cell resin foam,
the reinforcement section is constituted of a resin layer and a cord layer including a cord wound in the tire circumferential direction formed in the resin layer and
grooves are formed in a direction perpendicular to the tire circumferential direction on the inner peripheral surface of the resin layer.

8. The run-flat tire support according to claim 7, wherein plural grooves not only extend in the width direction of the reinforcement layer, but are also formed at a predetermined pitch in the tire circumferential direction.

9. The run-flat tire support according to claim 7, wherein a closed cell resin foam from which the base section is made is a closed cell polyurethane resin foam.

10. A manufacturing method for an annular run-flat tire support mounted to a rim in a run-flat tire, the run-flat tire support including: a base section made from a closed cell resin foam; a non-foam resin outer layer provided on the outer peripheral surface side of the base section; and a reinforcement section provided on the inner peripheral surface side of the base section, wherein
a process for forming the reinforcement section comprises:
a cord layer forming step of winding a cord along the tire circumferential direction on the outer peripheral surface of an inner mold, which has protrusions extending in a direction perpendicular to the tire circumpherential direction on the outer peripheral surface thereof and which forms a rim mounting surface of the run-flat tire support thereon; and
a resin layer forming step of forming a resin layer with a resin forming material supplied into the cord layer obtained by winding the cord.

11. A run-flat tire to which a run-flat tire support according to claim 7 is mounted.

12. The run-flat tire according to claim 11, wherein a lubricant with a low swellability is applied to at least one of the inner surface of a tire and the outer peripheral surface of the run-flat tire support, the lubricant being low in swellability both on a rubber material from which the inner surface of a tire is made and on a material from which the outer peripheral surface of the run-flat tire support is made.

13. The run-flat tire support according to claim 1, wherein not only is the outer side reinforcement fiber layer provided in the inner peripheral side of the non-foam resin outer layer, but the inner reinforcement fiber layer is also provided in the reinforcement section.

14. The run-flat tire support according to claim 13, wherein the reinforcement section is made from a non-foam resin and the inner side reinforcement fiber layer is embedded inside the reinforcement section.

15. The run-flat tire support according to claim 13, wherein the resin foam is a closed cell polyurethane resin foam with an average cell diameter in the range of from 20 to 200 μm.

16. The run-flat tire support according to claim 13, wherein the base section has plural recesses on the side surfaces thereof.

17. The run-flat tire support according to claim 13, wherein many of grooves are formed on the surface of the non-foam resin outer layer.

18. A run-flat tire to which a run-flat tire support according to claim 13 is mounted.

19. The run-flat tire according to claim 18, wherein a lubricant with a low swellability is applied to at least one of the inner surface of a tire and the outer peripheral surface of the run-flat tire support, the lubricant being low in swellability both on a rubber material from which the inner surface of a tire is made and on a material from which the outer peripheral surface of the run-flat tire support is made.

20. The run-flat tire support according to claim 1, wherein the base section is made from a closed cell resin foam and
the reinforcement section includes: a non-foam resin and a composite reinforcement fiber layer constituted of a fiber layer on the rim side formed in the non-foam resin and a cord layer wound around the outer side of the fiber layer in the circumferential direction of the rim.

21. The run-flat tire support according to claim 20, wherein a winding tension in the cord layer is higher than a winding tension in the fiber layer.

22. The run-flat tire support according to claim 20, wherein a closed cell resin foam from which the base section is made is a closed cell polyurethane resin foam.

23. A manufacturing method for a run-flat tire support mounted to a rim of a run-flat tire,
the run-flat tire support including: a base section made from a closed cell resin foam; a reinforcement section provided on the rim mounting side of the base section; and a non-foam resin outer layer provided on the outer peripheral surface side of the base section facing the inner surface of the tire,
wherein a process for forming the reinforcement section includes:
a fiber layer winding step of winding a fiber layer forming material around the outer peripheral surface of the inner mold forming a rim mounting surface of the run-flat tire support; a cord layer winding step of winding a cord layer around the outer side of the fiber layer with a tension stronger than in the fiber layer winding step; and a reinforcement forming step of forming the reinforcement section by supplying a non-foam resin forming material to a composite reinforcement fiber layer constituted of the fiber layer and the cord layer to cause the non-foam resin forming material to be reaction-cured.

24. A run-flat tire to which a run-flat tire support according to claim 20 is mounted.

25. The run-flat tire according to claim 24, wherein a lubricant with a low swellability is applied to at least one of the inner surface of a tire and the outer peripheral surface of the run-flat tire support, the lubricant being low in swellability both on a rubber material from which the inner surface of a tire is made and on a material from which the outer peripheral surface of the run-flat tire support is made.

26. A manufacturing method for a run-flat tire support mounted to a rim of a run-flat tire,
using a mold constituted of an inner mold forming a rim mounting surface; an outer mold forming the outer peripheral surface facing the inner diameter of the tire; and a first lateral mold and a second lateral mold forming side surfaces, including:
a reinforcement fiber layer forming step of forming a reinforcement fiber layer on the outer periphery of the inner mold;
a non-foam resin outer layer forming step of forming a film of a non-foam resin forming raw material on the inner peripheral surface of the outer mold;
a reinforcement section forming step of forming a reinforcement section having a rim mounting surface by coating the non-foam resin forming raw material on the reinforcement fiber layer;
a resin foam raw material supply step of supplying a closed cell resin foam raw material which forms a base section in a cavity formed with the non-foam resin outer layer, the reinforcement section, the first lateral mold and the second lateral mold; and
a curing step.

27. The manufacturing method for a run-flat tire support according to claim 26, wherein a closed cell resin foam from which the base section is made is a closed cell polyurethane resin foam.

28. The manufacturing method for a run-flat tire support according to claim 26, wherein a non-foam resin from which the non-foam resin outer layer is made and a non-foam resin from which the reinforcement section is made are both a reaction-curable polyurethane resin.

29. The manufacturing method for a run-flat tire support according to claim 26, wherein plural recesses are formed at least one side surface of the base section.

30. A run-flat tire to which a run-flat tire support manufactured by means of a manufacturing method for a run-flat tire support according to claim 26 is mounted.

31. The run-flat tire according to claim 30, wherein a lubricant with a low swellability is applied to at least one of the inner surface of a tire and the outer peripheral surface of the run-flat tire support, the lubricant being low in swellability both on a rubber material from which the inner surface of a tire is made and on a material from which the outer peripheral surface of the run-flat tire support is made.
